(19) United States
(12) Patent Application Publication
(10) Pub. No.: US 2024/0350913 A1
(43) Pub. Date: Oct. 24, 2024

(54) Picture Display

(71) Applicant: Tencent Technology (Shenzhen) Company Limited, Shenzhen (CN)

(72) Inventors: Renji Lu, Shenzhen (CN); Jie Hou, Shenzhen (CN)

(21) Appl. No.: 18/669,643

(22) Filed: May 21, 2024

Related U.S. Application Data
(63) Continuation of application No. PCT/CN2023/091882, filed on Apr. 28, 2023.

(30) Foreign Application Priority Data
Jun. 29, 2022 (CN) 2022107645929

(51) Int. Cl. A63F 13/5252; A63F 13/5372; A63F 13/69

(52) U.S. Cl. CPC A63F 13/5252; A63F 13/5372; A63F 13/69

(57) ABSTRACT

Picture display methods and apparatuses relating to the field of interactive entertainment, computer and Internet technologies are described herein. An illustrative method includes: displaying a virtual environment picture in a current round of an arena game, the first virtual object being a winner of a historical round of the current round, a first virtual camera being set in a birth/spawn point area of the first virtual object in the current round, and the first virtual object having a right to control the first virtual camera; and displaying, in response to a picture switching operation performed by the first virtual object, a first camera picture captured by the first virtual camera. The right to control the virtual camera at the birth point is given to the winner of the historical round of the current round, so that a user can learn of situations of the birth point area in real time. This enriches implementation of a round point advantage, so that the implementation of the round point advantage is more diverse and flexible.

### RELATED APPLICATION

This application is a continuation of and claims priority to PCT Application PCT/CN2023/091882, filed Apr. 28, 2023, which claims priority to Chinese Patent Application No. 202210764592.9, filed on Jun. 29, 2022, each entitled “PICTURE DISPLAY METHOD AND APPARATUS, DEVICE, STORAGE MEDIUM, AND PROGRAM PRODUCT”, and each of which is incorporated herein by reference in its entirety.

### FIELD

Aspects described herein relate to the field of computer and Internet technologies, and in particular, to a picture display method and apparatus, a device, a storage medium, and a program product.

### BACKGROUND

In a shooting game, there are usually several rounds. After a user-controlled virtual object wins a round, the virtual object usually gains a specific advantage in a next round, which is referred to as a round point advantage.

In the related art, the round point advantage is generally an attribute bonus or some specific virtual items as rewards given to the user-controlled virtual object.

However, in the related art, the implementation of the round point advantage is undiversified.

### SUMMARY

Aspects described herein provide a picture display method and apparatus, a device, a storage medium, and a program product. The technical solutions include the following:

According to an aspect, a picture display method is provided. The method is performed by a terminal device, and includes:
displaying a virtual environment picture in a current round of an arena game, the virtual environment picture being a display picture of a virtual environment of the current round observed from a perspective corresponding to a first virtual object participating in the current round, the first virtual object being a winner of a historical round of the current round, a first virtual camera being set in a birth or spawn point area of the first virtual object in the current round, and the first virtual object having a right to control the first virtual camera; and
displaying, in response to a picture switching operation performed by the first virtual object, a first camera picture captured by the first virtual camera.

According to an aspect, a picture display apparatus is provided. The apparatus includes:
a first display module configured to display a virtual environment picture in a current round of an arena game, the virtual environment picture being a display picture of a virtual environment of the current round observed from a perspective corresponding to a first virtual object participating in the current round, the first virtual object being a winner of a historical round of the current round, a first virtual camera being set in a birth or spawn point area of the first virtual object in the current round, and the first virtual object having a right to control the first virtual camera; and
a second display module, configured to display, in response to a picture switching operation performed by the first virtual object, a first camera picture captured by the first virtual camera.

According to an aspect, a terminal device is provided. The terminal device includes a processor and a memory, the memory stores a computer program, and the computer program is loaded and executed by the processor to implement the foregoing method.

According to an aspect, a computer-readable storage medium is provided. The readable storage medium stores a computer program, and the computer program is loaded and executed by a processor to implement the foregoing method.

According to an aspect, a computer program product is provided. The computer program product includes computer instructions, and the computer instructions are stored in a computer-readable storage medium. A processor of a terminal device reads the computer instructions from the computer-readable storage medium, and executes the computer instructions, so that the terminal device performs the foregoing method.

The technical solutions provided in this application may include the following beneficial effects:

When the first virtual object is a winner of a historical round of the current round, the first virtual object has a right to control the first virtual camera, and in response to the picture switching operation, the virtual environment picture is switched to the camera picture captured by the virtual camera. Therefore, the technical solutions provided in this application enrich implementation of a round point advantage, so that the implementation of the round point advantage is more diverse and flexible. In addition, a party that has a round point advantage can quickly view the birth/spawn point area by viewing the camera picture of the virtual camera without the need to control the virtual object to walk to the birth/spawn point area, improving convenience and efficiency of the operation, and reducing processing overhead of the terminal device.

Moreover, the camera picture obtained by capturing the birth/spawn point area by the virtual camera is provided to the winner of the historical round, so that the user controlling the first virtual object can learn of specific situations of the birth/spawn point area in real time, and raise vigilance in time when a virtual character of another camp (also, team) appears near the birth/spawn point area of the first virtual object. Therefore, the game is more strategic and more maneuverable.

### BRIEF DESCRIPTION OF THE DRAWINGS

FIG. 1 is a schematic diagram of a solution implementation environment according to one or more illustrative aspects described herein.

FIG. 2 is a schematic diagram of a picture display method according to one or more illustrative aspects described herein.

FIG. 3 is a schematic diagram of a process of transforming a three-dimensional space into a two-dimensional image according to one or more illustrative aspects described herein.

FIG. 4 is a flowchart of a picture display method according to one or more illustrative aspects described herein.

FIG. 5 is a schematic diagram of a user interface according to one or more illustrative aspects described herein.

FIG. 6 is a schematic diagram of a user interface according to one or more illustrative aspects described herein.

FIG. 7 is a schematic diagram of a user interface according to one or more illustrative aspects described herein.

FIG. 8 is a schematic diagram of a camera picture according to one or more illustrative aspects described herein.

FIG. 9 is a flowchart of a picture display method according to one or more illustrative aspects described herein.

FIG. 10 is a schematic diagram of a birth point area according to one or more illustrative aspects described herein.

FIG. 11 is a schematic diagram of a usage status of a virtual camera according to one or more illustrative aspects described herein.

FIG. 12 is a schematic diagram of a camera picture according to one or more illustrative aspects described herein.

FIG. 13 is a schematic diagram of a camera picture according to one or more illustrative aspects described herein.

FIG. 14 is a schematic diagram of a user interface according to one or more illustrative aspects described herein.

FIG. 15 is a flowchart of a picture display method according to one or more illustrative aspects described herein.

FIG. 16 is a flowchart of a picture display method according to one or more illustrative aspects described herein.

FIG. 17 is a schematic diagram of a target virtual equipment according to one or more illustrative aspects described herein.

FIG. 18 is a schematic diagram of a target virtual equipment according to one or more illustrative aspects described herein.

FIG. 19 is a flowchart of a picture display method according to one or more illustrative aspects described herein.

FIG. 20 is a block diagram of a picture display apparatus according to one or more illustrative aspects described herein.

FIG. 21 is a block diagram of a picture display apparatus according to one or more illustrative aspects described herein.

FIG. 22 is a block diagram of a structure of a terminal device according to one or more illustrative aspects described herein.

### DESCRIPTION OF EMBODIMENTS

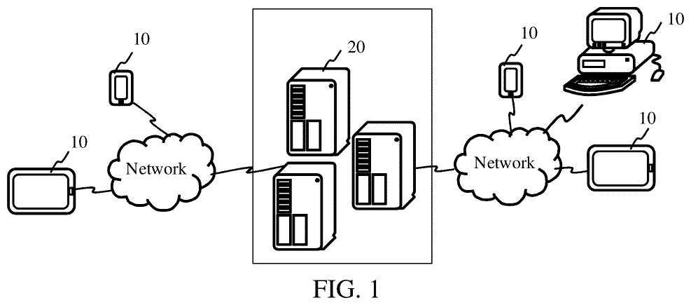

FIG. 1 is a schematic diagram of a solution implementation environment according to an illustrative aspect. The solution implementation environment may be implemented as a picture display system. The solution implementation environment may include: a terminal device 10 and a server 20.

The terminal device 10 may be an electronic device such as a mobile phone, a tablet computer, a game console, an ebook reader, a multimedia player, a wearable device, or a personal computer (PC). A client of a target application (for example, a game application) may be installed in the terminal device 10. The target application may be an application that needs to be downloaded and installed, or may be a click-to-use application, and the form of installation/use is not limited herein.

In one aspect, the target application may be a shooting application that can provide a virtual environment for a virtual character substituted and operated by a user to perform activities such as walking and shooting. Typically, the shooting application may be a Third-Personal Shooting Game (TPS), a First-person shooting game (FPS), a Multiplayer Online Battle Arena (MOBA) game, a multiplayer gunfight survival game, a Virtual Reality (VR) shooting application, an Augmented Reality (AR) application, a three-dimensional (3D) map program, a social application, an interactive entertainment application, or any application having a shooting product function. Moreover, virtual objects provided in different applications have different forms and corresponding functions, which may be designed according to an actual requirement, and this is not limited herein. A client of the foregoing application may be run on the terminal device 10. The application may be an application developed based on a 3D virtual environment engine. For example, the virtual environment engine is a Unity engine. The virtual environment engine may construct a 3D virtual environment, virtual objects, virtual items, and the like, to bring a more immersive gaming experience to the user.

The foregoing virtual environment is a scene displayed (or provided) when the client of the target application (for example, a game application) runs on the terminal device. The virtual environment is a scene created for a virtual object to perform activities (for example, game competition), and is, for example, a virtual house, a virtual island, or a virtual map. The virtual environment may be a simulated environment of the real world, or may be a semi-simulated semi-fictional environment, or may be an entirely fictional environment. The virtual environment may be a two-dimensional (2D) virtual environment, a 2.5-dimensional virtual environment, or a 3D virtual environment, and this is not limited in this embodiment of this application.

The foregoing virtual object may be a virtual character controlled by a user account in the target application. For example, the target application may be a game application. The virtual object may be a game character controlled by the user account in the game application. The virtual object may be in a human form, an animal form, a cartoon form, or another form, and this is not limited herein. The virtual object may be presented in a 3D form or a 2D form, and this is not limited herein. When the virtual environment is a 3D virtual environment, the virtual object may be a 3D model created based on a skeletal animation technology. Each virtual object has a respective shape and size in the 3D virtual environment, and occupies some space in the 3D virtual environment.

There may be a plurality of virtual objects in the virtual environment. A first virtual object and a third virtual object may be in a same camp, where the first virtual object is a virtual character controlled by a user. As used herein, camp and team may be used interchangeably. The user may refer to a user or an owner of the user account to which the client logs in. There may be one or more first virtual objects, i.e., in a same shooting application, the user may control one first virtual object or a plurality of first virtual objects. Taking a shooting game as an example, in different shooting game rounds, the user controls different first virtual objects to play the game. Alternatively, in one shooting game round, the user simultaneously controls a plurality of first virtual objects in cooperation to play the game. A second virtual object may be in an opposing camp of the camp to which the first virtual object belongs, and the second virtual object may be a virtual object controlled by another user, a virtual character controlled by a computer program in the application, a virtual building that can be destroyed, a virtual article that can be destroyed, or the like. The server 20 is configured to provide a backend service for the client that is of the target application and that is installed and run on the terminal device 10. For example, the server 20 may be a backend server for the foregoing game application. The server 20 may be one server, a server cluster including a plurality of servers, or a cloud computing service center. In some embodiments, the server 20 provides backend services for target applications in a plurality of terminal devices 10 simultaneously.

During the game, the terminal device 10 and the server 20 communicate with each other through a network.

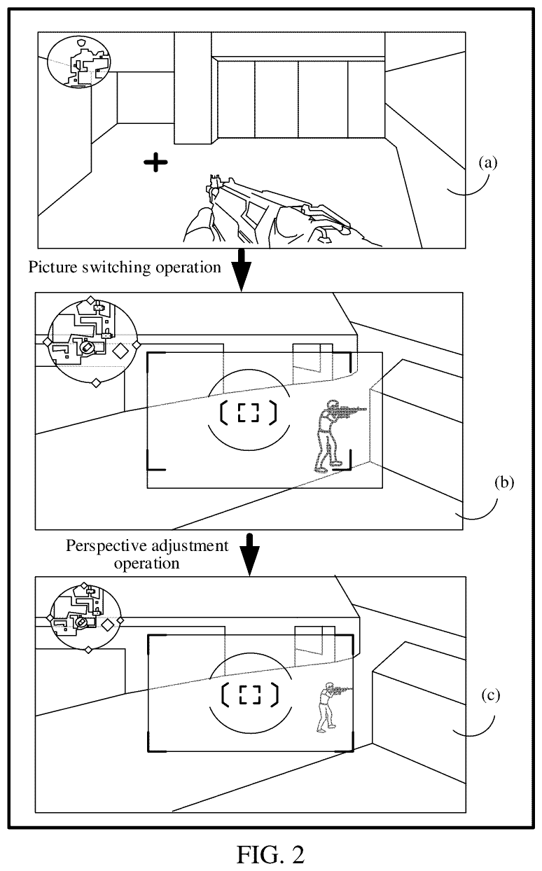

FIG. 2 is a schematic diagram of an illustrative picture display method. On the terminal device 10 shown in FIG. 1, a virtual environment picture (as shown in (a) in FIG. 2) is displayed. When a virtual object controlled by a user is a winner of a historical round of a current round, the virtual environment picture (as shown in (a) in FIG. 2) is switched, through a picture switching operation performed by the user, to a camera picture (as shown in (b) in FIG. 2) captured by a virtual camera. Further, the user may further adjust a perspective of the virtual camera through a perspective adjustment operation (described further below) to adjust the camera picture as shown in (b) in FIG. 2 to another camera picture (as shown in (c) in FIG. 2) of the virtual camera of from another perspective. A right to control the virtual camera is given to the winner of the historical round of the current round, to enrich implementation of a round point advantage. A camera picture of a birth point area is directly switched to, thereby improving operation efficiency of the user to view the birth point area, and reducing processing overhead of the terminal device. As used herein, a birth point area may also and interchangeably be referred to as a spawn point, and vice versa. A photographing principle of photographing a virtual environment by a virtual lens and a virtual camera in this application is first described.

A virtual environment is provided in an arena game of a target application, where the virtual environment is an environment in which a virtual character is located in a virtual world. In some aspects, the virtual environment is a 3D space. A world space coordinate system is used to describe coordinates of a 3D model in the virtual environment in a same scene. The 3D model is an object in the virtual environment.

The virtual lens and the virtual camera are set in the virtual environment for capturing the virtual environment to generate a virtual environment picture or a camera picture. The virtual lens may follow the virtual character to move in the virtual environment, and the virtual environment picture captured by the virtual lens can represent the virtual environment in which the virtual character is located, and changes of the virtual environment during movement of the virtual character. A set location of the virtual camera in the virtual environment may be independent of the virtual character. That is, during movement of the virtual character in the virtual environment, the set location of the virtual camera might not change with movement of the virtual character. The virtual camera may be placed in the virtual environment, for example, the virtual camera may be placed on a surface of a virtual article that is not reachable by the virtual character. For example, the virtual camera may be set on a surface of a virtual building in the virtual environment, and the virtual camera captures the virtual environment at the set location, to obtain a camera picture.

Both the virtual lens and the virtual camera are camera models, where a camera model is a model used in computer graphics for observing a virtual world. A camera model is described below by using the virtual lens as an example. The virtual lens automatically follows the virtual character in the virtual world. That is, when the location of the virtual character changes in the virtual world, the location of the camera model following the virtual character changes simultaneously in the virtual world, and the camera model is always located in a preset distance range of the virtual character in the virtual world. In the automatic following process, relative locations of the camera model and the virtual character do not change. The camera model captures the virtual environment, to obtain a virtual environment picture.

In an example, an imaging plane of the virtual environment picture is a plane perpendicular to a photographing direction of the camera model. For example, when the camera model performs photographing from above from a third person perspective, the imaging plane is a horizontal plane in the virtual environment. When the camera model performs photographing head-up from a first person perspective, the imaging plane is parallel to a vertical direction. The horizontal plane is a plane perpendicular to a simulated direction of gravity in the virtual environment, and the vertical direction is parallel to the simulated direction of gravity in the virtual environment. For example, the camera model is also referred to as a virtual camera. The photographing direction to which the camera model points is perpendicular to the imaging plane. The imaging plane is typically a rectangle, and is also referred to as an imaging rectangle. Virtual photosensitive elements on the imaging plane are in one-to-one correspondence with pixels on a terminal screen, and the virtual photosensitive elements record light intensity and colors when the virtual character is observed by the camera model. For example, for an introduction to the camera model, refer to a book published by the Electronic Industry Press in February 2019: Game Engine Architecture: 2^{nd} Edition/(USA) written by Jason Gregory; translated by Ye Jinsong, where references include but are not limited to content in Chapter 10, Section 10.1: Basics of Triangular Rasterization Using Depth Buffering, especially content in Section 10.1.4: Virtual Camera. Reference may be further made to a book published by China Railway Press in January 2016: Unity5.X from Entry to Proficiency/Edited by Unity Software (Shanghai) Co., Ltd., where references include but are not limited to content about a camera in Chapter 6 Creating Basic 3D Game Scene.

Coordinates of a virtual article, a virtual character, a virtual lens, and a virtual camera included in the virtual environment may be represented by a world coordinate system. For example, the world space coordinate system may be transformed from a 3D model in a model space coordinate system by using a model transformation matrix. The model space coordinate system indicates location information of the 3D model. Coordinate information of each 3D model in the model space coordinate system is unified into the world space coordinate system in the 3D space by using the model transformation matrix.

For example, the 3D model in the world space coordinate system is transformed into a camera space coordinate system by using a view matrix. The camera space coordinate system is configured for describing coordinates of the 3D model observed by using the camera model. For example, a location of the camera model is used as a coordinate origin. The 3D model of the camera space coordinate system is transformed into a cropped space coordinate system by using a projection matrix. The cropped space coordinate system is configured for describing a projection of the 3D model in a view frustum of the camera model. A commonly used perspective projection matrix (a type of projection matrix) is used to project the 3D model into a model that conforms to a human eye observing rule of “near-large-far-small”. For example, the model transformation matrix, the view matrix, and the projection matrix described above are generally collectively referred to as model view projection (MVP) matrixes.

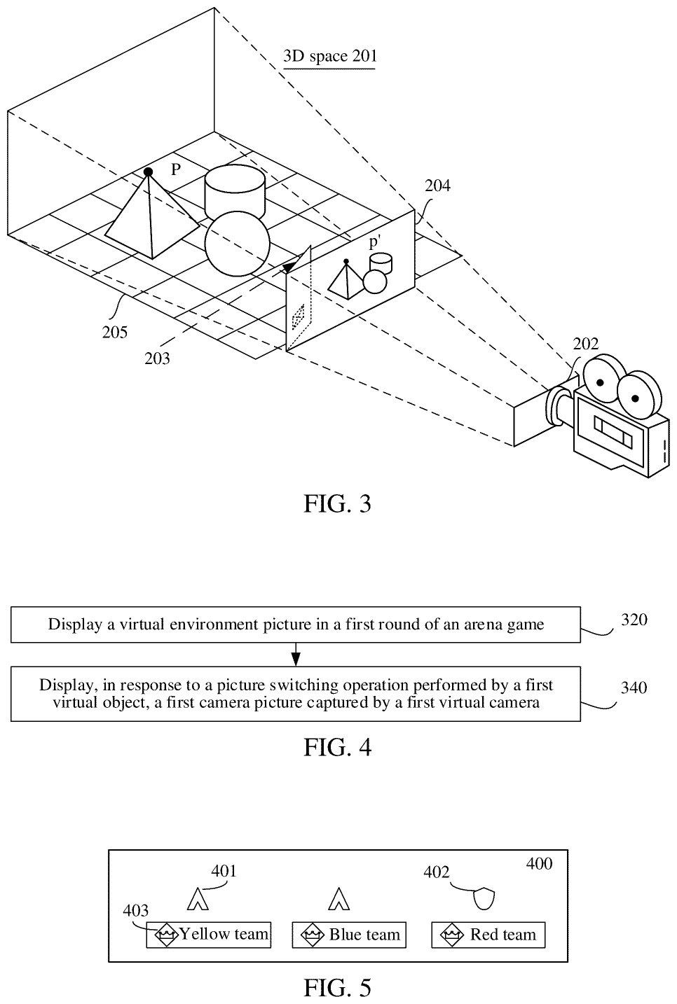

FIG. 3 is a schematic diagram of a process of transforming a 3D space into a 2D image according to an example embodiment of this application. A process of mapping a feature point p in a 3D space 201 to a feature point p′ in an imaging plane 204 (an image coordinate system, or referred to as a pixel coordinate system) is illustrated with reference to FIG. 3. Coordinates of the feature point p in the 3D space 201 are in 3D form, and coordinates of the feature point p′ on the imaging plane 204 are in 2D form. The 3D space 201 is a 3D space corresponding to a virtual environment. A camera plane 202 is determined by a pose of a camera model, the camera plane 202 is a plane perpendicular to a photographing direction of the camera model, and the imaging plane 204 and the camera plane 202 are parallel to each other. The imaging plane 104 is within a field of view when the virtual environment is observed.

The virtual lens and the virtual camera according to this application obtain the virtual environment picture and the camera picture based on the camera model and the imaging principle in the foregoing content, so that the virtual environment picture and the camera picture according to the picture display method provided in this application can be displayed on a user interface.

FIG. 4 is an illustrative flowchart of a picture display method. An entity executing the operations of the method may be the terminal device 10 in the solution implementation environment shown in FIG. 1. For example, the execution entity of each operation may be the client of the target application. In the following method embodiments, for ease of description, the execution of the operations by a “client” is described as an example. The method may include at least one of the following operations (320 to 340):

Operation 320: Display a virtual environment picture in a first round of an arena game.

First round: It refers to a specific round in the game. The first round may be a currently ongoing round. In other words, the first round may be a current round. There may be a plurality of rounds in the arena game, and each round may include a plurality of small rounds. The first round may be a round including a plurality of small rounds, or may be a small round in a specific round.

For example, in a game between a red team and a blue team, a best-of-five-round system may be used, and a team that wins first three rounds wins the arena game. In another example, in the game between the red team and the blue team, a two-round winning system is used, and a team who wins first two rounds wins the arena game. The currently ongoing round may be a second round. In this case, the current round is the second round. The technical solutions provided in this application may be applied to each small round of the first round.

Virtual environment picture: It is a picture of a virtual environment observed from a perspective corresponding to a first virtual object. The virtual environment includes the first virtual object. The virtual environment may be different for each round. Therefore, the virtual environment picture for each round might not be exactly the same.

The virtual environment picture may be a picture of the virtual environment of the first round observed from the perspective corresponding to the first virtual object participating in the first round. The perspective of the virtual object may be a third perspective of the virtual object or a first perspective of the virtual object. The virtual environment picture may be displayed to a user through a user interface. The virtual environment picture is a picture obtained from the virtual environment by using a virtual lens.

In one illustrative aspect, the virtual lens may obtain the virtual environment picture from the third-person perspective. In some aspects, the virtual lens may be set obliquely above the first virtual object. Through the virtual lens, a client observes the virtual environment with the virtual object as a center, and obtains and displays the virtual environment picture centered on the first virtual object. In another possible implementation, the virtual lens obtains the virtual environment picture from the first perspective of the first virtual object. They virtual lens may be set directly in front of the first virtual object. Through the virtual lens, the client observes the virtual environment from the perspective of the first virtual object, and obtains and displays the virtual environment picture with the first virtual object in first-person perspective.

In addition, a placement location of the virtual lens may be adjustable in real time. The user may adjust the location of the virtual lens through a touch operation on the user interface (or other user interface interaction), to obtain virtual environment pictures of the virtual environment at different locations. The touch operation on the user interface may include, but is not limited to, at least one of the following: a swipe operation, a click/tap operation, and the like. For example, the touch operation may be the swipe operation, and the user drags the virtual environment picture through the swipe operation to adjust the location of the virtual lens. In another example, the touch operation may be the click/tap operation. The user adjusts the location of the virtual lens by clicking/tapping a specific location in a map display control as the adjusted location of the virtual lens, where the map display control is configured to display a global map of the virtual environment. The first virtual object may be a winner of a historical round of the first round. The winner refers to a camp (also referred to as a team) that wins in the round, and the camp includes at least one virtual object. Historical round: It is a round before the first round. In other words, the historical round occurs before the first round, and the first round is entered after the historical round ends. The historical round may refer to any round that occurs before the first round. When the first round is the current round, the historical round is a round before the current round. An arena game may include a plurality of rounds. An arena game may include at least: a first round and a historical round. For example, an arena game includes a first round, a historical round, and a round after the first round. For example, an arena game includes four rounds, a first round is a third round, and historical rounds are the first round and a second round. After all rounds included in an arena game end, the arena game ends. An arena game may include up to five rounds, involving two teams. When one of the two teams wins at least three rounds, the arena game ends.

The winner of the historical round refers to a party that wins in the historical round. The winner of the historical round may be a winner of a previous round before the first round. For example, the first round is a third round. In this case, the historical round is a second round, and the winner of the historical round is a party that wins in the second round.

A round may be divided into a plurality of small rounds, and winning of the round refers to winning of more than half of the small rounds. A round may be divided into three small rounds, and if a team wins two small rounds in the game, the team wins the round.

The winner of the historical round may be a winner of any round before the first round. In one example, the current round is a fifth round. In this case, the historical round may be any of a first round to a fourth round. For example, the winner of the historical round could be a party that wins in the second round.

In another example, the first round is a third round, the red team wins in a first round, and the blue team wins in a second round. In this case, in the third round, both the red team and the blue team are winners of the historical rounds.

The winner of the historical round may be a winner that wins at least two rounds before the first round. In one example, the current round is a fourth round, historical rounds are a first round, a second round, and a third round, the red team wins in both the first round and the second round, and a yellow team wins in the third round. In this case, the red team is a winner of the historical rounds. A round point advantage is gained by the red team in the third round and the fourth round, while the yellow team cannot gain the round point advantage because it is not the winner of the historical rounds.

A round may have several small rounds, and a team that wins the most small rounds wins the current round. A round may have three small rounds, the red team wins two small rounds, and the yellow team wins one small round. In this case, the red team is the winner of the historical rounds.

If at least two teams in a round respectively win small rounds of a same quantity, an additional round may be added, and a winner of the additional round is a winner of the historical rounds. For example, if a round includes three small rounds, there are three teams of red, yellow, and blue competing, and each of the three teams of red, yellow, and blue wins a small round, an overtime round is added, and a winner of the overtime round is a winner of the historical rounds of the first round. Assuming that the winner of the overtime round is the red team, the red team is the winner of the historical rounds.

FIG. 5 is an illustrative schematic diagram of a user interface. As shown in FIG. 5, three teams are shown in a user interface 400, where an icon 401 is an attacking-party mark, and if the attacking-party mark 401 is displayed above a name of a team, it indicates that the team is an attacking party. That is, the icon 401 in FIG. 5 indicates that a yellow team is an attacking party in a current small round in a current round, and similarly, a blue team in FIG. 5 is also an attacking party. An icon 402 is a defending-party mark, and if the defending-party mark 402 is displayed above a name of a team, it indicates that the team is a defending party. That is, the icon 402 in FIG. 5 indicates that a red team is a defending party in the current small round in the current round. The icon 403 is a winning mark, which indicates that the team is a winner of a historical round and therefore has a round point advantage in the current small round of the current round. In the user interface 400, the red team, the yellow team, and a blue team are all winners of historical rounds.

Three teams may be included in an arena game, where one of the teams is a defending party and the other two teams are attacking parties. There may be a plurality of rounds in an arena game, where one round includes three small rounds, each small round has a team acting as a defending party, and teams acting as defending parties in the three small rounds are different.

At the beginning of each small round, a team acting as a defending party may vote to select a birth point. For example, a game map may have three birth points: A, B, and C in the current round. When the red team acts as the defending party, a birth point selected by teammates of the red team through voting is the point A. In this case, the point A is a location where all virtual objects of the red team initially appear after the start of the round. After the defending party selects the birth point, the remaining two attacking teams select birth points. In some examples, the attacking teams vote to select the remaining birth points.

For example, after the red team selects the point A, the yellow and blue teams vote to select respective birth points from the points B and C. To avoid a plurality of attacking teams competing for a specific birth point, a server may randomly select birth points respectively corresponding to at least one attacking team. The arena game may end after a team wins two rounds, and the team wins the arena game.

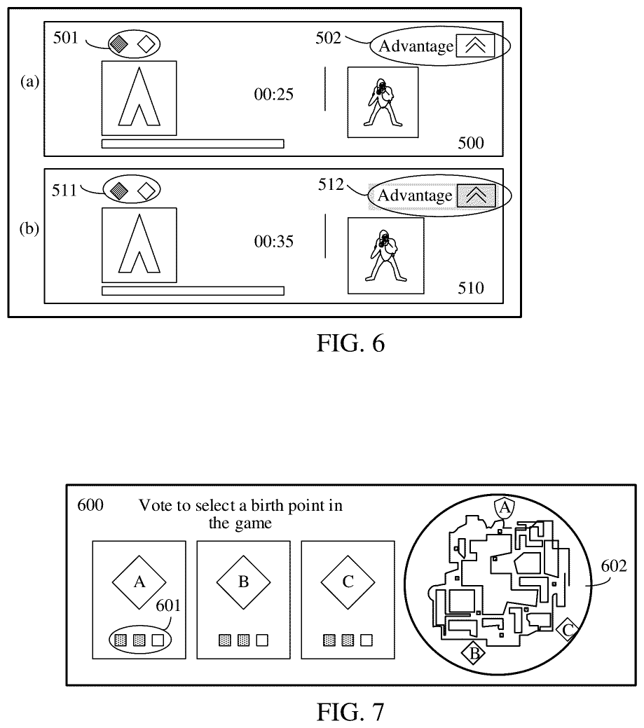

FIG. 6 is a comparison diagram of two user interfaces. Sub-diagram (a) in FIG. 6 is a schematic diagram of a user interface according to an illustrative aspect. As shown in sub-diagram (a) in FIG. 6, a user interface 500 is a user interface of a winner of a historical round, where an icon 501 indicates that the user has won one round, and is to win the arena game after winning another round. An “advantage” typeface in a mark 502 indicates that the current team is a winner of a historical round and has a round point advantage.

Sub-diagram (b) in FIG. 6 is an illustrative schematic diagram of a user interface according to another aspect. As shown in sub-diagram (b) in FIG. 6, a user interface 510 is a user interface of a non-winner of a historical round (namely, a loser of the historical round), where an icon 511 indicates that the user has won one round, and can win the arena game by winning another round. A mark 512 is in an unlit state, indicating that the current team is not a winner of a historical round and does not have a round point advantage.

A first virtual object may refers to any virtual object in a camp corresponding to the winner of the historical round. All virtual objects included in the camp corresponding to the winner of the historical round may be first virtual objects. After the server determines the winner of the historical round, the server provides a round point advantage for the camp corresponding to the winner of the historical round, where the round point advantage includes enabling all virtual objects included in the camp corresponding to the winner of the historical round to have a capability to use a virtual camera in a virtual environment.

In this example, during running of a shooting application, a client displays a virtual environment picture, where the virtual environment includes a first virtual object and a first virtual camera. In some embodiments, in the shooting application, the user controls the first virtual object to view a real-time situation of a birth point area using the first virtual camera. In this example, a virtual lens and a virtual camera are of a same concept, and are both items capable of displaying pictures. In some embodiments, the virtual lens is configured to move following the virtual object, and capture an environment picture in a first-or third-person perspective range of the virtual object as a virtual environment picture. The virtual camera does not move with the movement of the virtual object. The virtual camera may be installed in the virtual environment, and a photographing range of the virtual camera is fixed or limited.

The virtual lens and the virtual camera may have a specific shape in a virtual game or may not have a specific shape and represent only a location point. There may be descriptions of the virtual camera such as “a plurality of virtual cameras”, “first virtual camera”, and “second virtual camera” in this application, where the plurality of virtual cameras includes the first virtual camera or the second virtual camera, the first virtual camera is any one of the plurality of virtual cameras, or the first virtual camera is a virtual camera with a highest selection priority in the plurality of virtual cameras. The second virtual camera is any one of the plurality of virtual cameras other than the first virtual camera, or a virtual camera with a lower priority than that of the first virtual camera in the plurality of virtual cameras. For an imaging principle of the virtual lens and the virtual camera, refer to the foregoing content, and details are not described herein again.

In this example, a first virtual camera is set in a birth point area of a first virtual object in a current round, and the first virtual object has a right to control the first virtual camera.

First virtual camera: It is a type of virtual item in the virtual environment. The first virtual camera is one of a plurality of virtual cameras. The first virtual camera might not have a specific shape in the virtual environment and represents only a location point. In other words, a first camera picture may be understood as a camera picture obtained by capturing the virtual environment at the location point of the first virtual camera.

The first virtual camera may be displayed in the virtual environment, and the first virtual camera may have a virtual shape in the virtual environment, such as a camera-like shape or a probe-like shape.

The server may provide winners of historical rounds with a right to control the virtual camera. That is, a user included in the winners of the historical rounds can view, through a picture display operation, a picture captured by the virtual camera, and the user has the right to control the virtual camera.

The first virtual camera may be set in the birth point area, and the birth point arca may include one or more virtual cameras. This is not limited in this application.

In one example, in a current round, both a red team and a blue team are winners of historical rounds. In this case, both the red team and the blue team can gain the right to control the virtual camera in the current round. A birth point of the red team may be point A, and a birth point of the blue team is a point B. After learning that the red team and the blue team are winners of the historical rounds, the server sets three cameras a1, a2, and a3 in a birth point area in which the point A is located, and sets three cameras b1, b2, and b3 in a place B. A user controlling a virtual object included in the red team can gain a right to control a virtual camera in the birth point area in which the point A is located. For the red team, the first virtual camera is any one of a1, a2, and a3. A user controlling a virtual object of the blue team can gain a right to control a virtual camera in the place B. For the blue team, the first virtual camera is any one of b1, b2, and b3.

The first virtual camera might not be set by the server, and a winner of a historical round has a permission to set at least one virtual camera. For example, after learning that the red team and the blue team are the winners of the historical rounds, the server gives the red team and the blue team permissions to place a virtual camera in the virtual environment and control the virtual camera, so that the users corresponding to the winners can control the virtual characters of the red team and the blue team to place a virtual camera and control the virtual camera.

The permission to control the virtual camera in this example includes, but is not limited to, calling up a picture captured by the virtual camera, controlling a movement location of the virtual camera, controlling the virtual camera to rotate, controlling the virtual camera to zoom in (to display the virtual environment at a close distance), controlling the virtual camera to zoom out (to display a wider range of virtual environment), and so on.

Birth point area: It is an area in which a birth point of the camp to which the first virtual object belongs is located. The birth point area is a concept of an area, not limited to a location of the birth point. The birth point area may be an area away from the birth point by a distance not greater than a threshold. As an example, the birth point may be the point A. In this case, any location point less than 20 m away from the point A belongs to the birth point area. In other words, the birth point area may be a circular area with the point A as a center and 20 m as a radius. A plurality of virtual cameras may be placed within the area with the point A as the center and 20 m as the radius, and the first virtual camera is one of the plurality of virtual cameras. A birth point may interchangeably be referred to as a spawn point.

The birth point area may be an area that delineates a space centered at the birth point. The birth point area may be an area in the virtual environment. For example, the birth point area may be a regular polygon area (for example, a square area). In another example, the birth point area may be an irregular area.

A plurality of virtual cameras may be respectively placed at different locations in the birth point area, and perspective ranges of the plurality of virtual cameras are different. In other words, the plurality of virtual cameras are pointed in different directions, and whether a second virtual object appears can be observed from different directions by using the plurality of virtual cameras.

In one example, there are three teams in an arena game, where one round has three small rounds, and each small round has one team acting as a defending party as a defending camp and two remaining teams acting as an attacking party as an attacking camp. After selecting a birth point, the team acting as the defending party may choose to raise a base tower in a birth point area. A main task of the defending party is to defend the base tower. After the attacking party interacts with the base tower, the base tower is occupied by the attacking party. The defending party needs to interact with the base tower again to be counted as the defending party and continue to defend. After the attacking party occupies the base tower, the base tower also needs to be defended. In response to a sneak attack or an attack by a second virtual object, the user may control the first virtual object to take precautions in time to prevent the own base tower from being occupied by the enemy.

FIG. 7 is an illustrative schematic diagram of a user interface. As shown in FIG. 7, a user interface 600 is a user interface of a defending party. The user interface 600 indicates that the defending party is voting for a birth point in a game. 601 indicates a voting result for a point A, where two teammates select the point A as a birth point.

For the winner of the historical round, a plurality of virtual cameras may be set in the birth point area, so that the user of the winner can view the picture captured by the virtual camera in the birth point area, to learn of the situation of the birth point area in time for subsequent attacking and defending deployments. There may be a plurality of virtual cameras set in the birth point area, and the first virtual object may gain a right to control the plurality of cameras. The winner of the historical round may unlock the virtual camera only in the current round. That is, the plurality of virtual cameras only appear in the next round when the team is the winner of the historical round, and the virtual objects in the camp to which the winner of the historical round belongs gain the right to control the virtual cameras.

In addition, operations (a picture switching operation, a camera switching operation, a perspective adjustment operation, and the like as described herein) of the first virtual object may be regarded as own operations of the first virtual object, or may be regarded as operations by the user controlling the first virtual object.

Operation 340: Display, in response to a picture switching operation performed by the first virtual object, a first camera picture captured by the first virtual camera.

Picture switching operation: It is a switching operation by the user for switching a virtual environment picture displayed in a user interface to a camera picture captured by a virtual camera. For example, the client of the target application is installed on a device with a touchpad. The picture switching operation may include at least one of a press operation, a touch operation on a specific control (where the control displays a surface layer of the virtual environment picture and is configured for switching the picture), a double click/tap operation, a shaking operation, a tap operation on an external device, and the like. The client of the target application may installed on a personal computer. The picture switching operation may then be a tap operation on a peripheral (for example, a mouse or a keyboard). The picture switching operation may include at least one of the following: clicking on a specific control on a computer screen by using the mouse, tapping a key on the keyboard (for example, a Z key on the keyboard), and so on. The device where the client is located is not limited in this application. Therefore, the type of the picture switching operation is not limited, and any operation for switching pictures can be used.

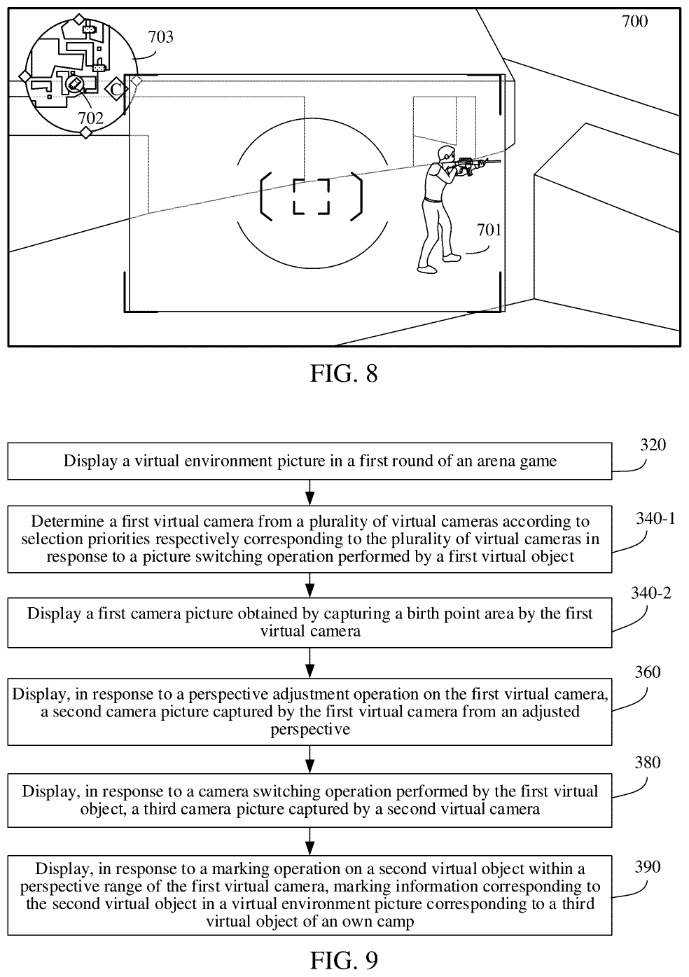

FIG. 8 is an illustrative schematic diagram of a camera picture. As shown in FIG. 8, a second virtual object 701 is displayed in a first camera picture 700. Moreover, a small map 703 of a user interface shows that a current first virtual camera is 702.

Based on the above, the round point advantage of the picture obtained by capturing the birth point area by the video camera capable of observing the birth point area is provided to the winner of the historical round, which enhances the strategic nature of the arena game, and enriches implementation of the round point advantage, so that the implementation of the round point advantage is more diverse and flexible. In addition, a party that has a round point advantage can quickly view the birth point by viewing the camera picture of the virtual camera without the need to control the virtual object to walk to the birth point area, improving convenience and efficiency of the operation, and reducing processing overhead of the terminal device.

Moreover, the winner of the historical round only gains the advantage of having the right to control the camera, and does not cause a one-sided suppression of the game. Teams that do not have the round point advantage do not easily fail, and still hold a great probability of winning in the current round. Therefore, the game is more interesting, and the user experience is better.

FIG. 9 is an illustrative flowchart of a picture display method. An entity executing the operations of the method may be the terminal device 10 in the solution implementation environment shown in FIG. 1. For example, the execution entity of each operation may be the client of the target application. In the following example, for ease of description, the execution entity of cach operation being a “client” is only used for description. The method may include at least one of the following operations (320 to 390):

Operation 320: Display a virtual environment picture in a current round of an arena game.

Operation 340-1: Determine a first virtual camera from a plurality of virtual cameras according to selection priorities respectively corresponding to the plurality of virtual cameras in response to a picture switching operation performed by the first virtual object.

Selection priority: It refers to a priority of the virtual camera to the first virtual object. In other words, effects or priorities of virtual cameras are not exactly the same. For example, when a virtual camera is pointed in a direction toward a corner, a photographing range of the virtual camera is limited, a probability of a second virtual object appearing in a camera picture provided by the virtual camera is lower, or a quantity of captured second virtual objects is lower. In other words, useful information provided by the virtual camera to the first virtual object is less. Therefore, a frequency at which the virtual camera is controlled is lower, and thus a priority of the virtual camera is lower.

The degree of usefulness/priority is not limited in this application. Distance may be used as a priority condition. According to distances between the first virtual object and the virtual cameras, priorities respectively corresponding to at least one virtual camera may be determined as a priority condition. Picture quality of a camera picture of a virtual camera may be used as a priority condition, and so on. As the round progresses, the priority condition may change. For example, at the beginning of the round, the priority condition is a distance between a virtual camera and the first virtual object. As the second virtual object approaches, the priority condition may change to a distance between a virtual camera and the second virtual object.

The first virtual camera may be determined from a plurality of virtual cameras according to the selection priority of the first virtual camera. A camera with a highest priority in the plurality of cameras may be used as the first virtual camera.

Before the operation of “determining a first virtual camera from a plurality of virtual cameras according to selection priorities respectively corresponding to the plurality of virtual cameras in response to a picture switching operation”, at least some of the following operations S1 to S3 (not shown in the figure) may be further included.

S1: Determine the selection priorities respectively corresponding to the plurality of virtual cameras according to distances between the first virtual object and the plurality of virtual cameras.

The client may determine the selection priorities respectively corresponding to the plurality of virtual cameras according to the corresponding distances between the first virtual object and the plurality of virtual cameras. A virtual camera closest to the first virtual object in the plurality of virtual cameras may have the highest selection priority.

The selection priorities may be ranked from high to low respectively into level 1, level 2, level 3, and so on. For example, there are three virtual cameras c1, c2, and c3 in a birth point area of a birth point A of a red team, where distances between c1, c2, and c3 and the first virtual object are 1 m, 2 m, and 3 m respectively. In this case, the virtual camera c1 is closest to the first virtual object, and a selection priority of the virtual camera c1 is level 1. In this case, the client uses the virtual camera c1 as the first virtual camera.

The smallest distance in the distances between the first virtual object and the plurality of virtual cameras is used as the highest selection priority, so that the user controlling the first virtual object can learn of changes in the environment around the first virtual object in time, to help the user perceive in time whether a second virtual object exists around the first virtual object, help improve user awareness of the virtual environment around the first virtual object, and improve the safety of the environment around the first virtual object.

The client may determine the selection priorities respectively corresponding to the plurality of virtual cameras according to the corresponding distances between the first virtual object and the plurality of virtual cameras. A virtual camera farthest from the first virtual object in the plurality of virtual cameras may have the highest selection priority. For example, the selection priorities are respectively level 1, level 2, level 3, and so on from high to low. In one example, there are three virtual cameras c1, c2, and c3 in a birth point area of a birth point A of a red team, where distances between c1, c2, and c3 and the first virtual object are 1 m, 2 m, and 3 m respectively. In this case, the virtual camera c3 is farthest from the first virtual object, and a selection priority of the virtual camera c3 is level 1. In this case, the client uses the virtual camera c3 as the first virtual camera.

The largest distance in the distances between the first virtual object and the plurality of virtual cameras is used as the highest selection priority, so that the user controlling the first virtual object can learn of a situation at a farther distance in time for further deployments.

S2: Determine the selection priorities respectively corresponding to the plurality of virtual cameras according to distances between a second virtual object and the plurality of virtual cameras, where the second virtual object and the first virtual object belong to different camps.

The distances between the second virtual object and the plurality of virtual cameras may be used as selection priorities. A smallest distance in the distances between the second virtual object and the plurality of virtual cameras may be used as the highest selection priority. The highest selection priority may be level 1, followed by level 2, level 3, and so on. In one example, there are three virtual cameras c1, c2, and c3 in a birth point area of a birth point A of a red team, where distances between c1, c2, and c3 and the second virtual object are 1 m, 2 m, and 3 m respectively. In this case, the virtual camera c1 is closest to the second virtual object, and a selection priority of the virtual camera c1 is level 1. In this case, the virtual camera c1 is used as the first virtual camera. The smallest distance in the distances between the second virtual object and the plurality of virtual cameras is used as the highest selection priority, so that the user controlling the first virtual object can learn immediately when the second virtual object appears in the own birth point area, for the user to quickly capture whereabouts of the second virtual object.

The client may determine the selection priorities respectively corresponding to the plurality of virtual cameras according to the corresponding distances between the second virtual object and the plurality of virtual cameras. A virtual camera farthest from the second virtual object in the plurality of virtual cameras may have the highest selection priority. For example, the selection priorities are respectively level 1, level 2, level 3, and so on from high to low. Assuming that there are three virtual cameras c1, c2, and c3 in a birth point area of a birth point A of a red team, where distances between c1, c2, and c3 and the second virtual object are 1 m, 2 m, and 3 m respectively, the virtual camera c3 is farthest from the second virtual object, and a selection priority of the virtual camera c3 is level 1. In this case, the virtual camera c3 is used as the first virtual camera.

The largest distance in the distances between the second virtual object and the plurality of virtual cameras is used as the highest selection priority, so that the user controlling the first virtual object can observe the second virtual object from a farther perspective, to help capture a plurality of second virtual objects simultaneously in the first camera picture, and obtain a further understanding of movement of the second virtual objects.

A virtual camera closest to the second virtual object in the plurality of virtual cameras may the highest selection priority. By using such a method, the user can first determine the second virtual object close to the virtual camera.

S3: Determine the selection priorities respectively corresponding to the plurality of virtual cameras according to priority configuration information, where the priority configuration information is configured by a system or configured by a user.

The priority configuration information is configuration information that represents the selection priority of the virtual camera.

The selection priority of the virtual camera may be configured by the system. Priority information of each virtual camera is configured before or after the first virtual object enters the game.

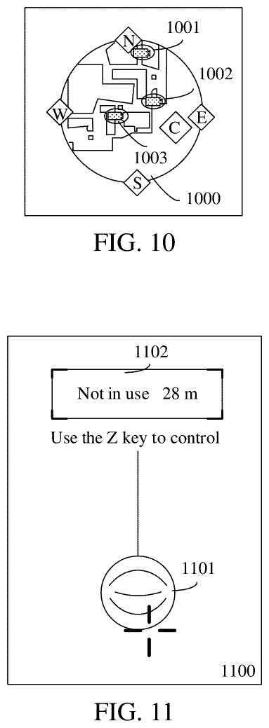

FIG. 10 is an illustrative schematic diagram of a birth point area. In a birth point area 1000 of a point C, there are three virtual cameras 1001, 1002, and 1003. Before or after the first virtual object enters a first round, it is configured by the system that a selection priority of the virtual camera 1001 is the highest, a selection priority of the virtual camera 1002 is second, and a selection priority of the virtual camera 1003 is the lowest. On one example, a blue team is a winner of a historical round, and a birth point of the blue team is the point C. In response to a picture switching operation by a user of the blue team, a first camera picture obtained by capturing the birth point area by the virtual camera 1001 is displayed.

The selection priority of the virtual camera may be configured by the user. Priority information of each virtual camera has been configured before or after the first virtual object enters the game.

In one example, before entering the game for the current round, the user of the blue team has learned that the own team is the winner of the historical round. The user of the blue team views a game map of the birth point before entering the game, and adjusts a selection priority of a virtual camera placed at a key location point to the highest selection priority. In this way, the camera picture of the virtual camera at the key location point can be preferentially displayed when the camera picture of the virtual camera is switched to.

For example, the blue team is a defending party. After entering the game, the blue team acts as the winner of the historical round, and the user of the blue team adjusts a selection priority of a virtual camera closest to a base tower to the highest, to learn of a situation of the base tower and immediately learn when the second virtual object approaches the base tower, raise vigilance, and be ready to battle.

The selection priorities of different virtual cameras can be determined in various manners, where one manner is based on the distances between the first virtual object and the virtual cameras, one manner is based on the distances between the second virtual object and the virtual cameras, and another manner is based on the configuration information. The different manners of determining the selection priorities enhance flexibility of the method for selecting the first virtual camera from the plurality of virtual cameras, and can satisfy different needs of the user. The user can respond quickly when there are enemies, which facilitates user operations in the game.

Operation 340-1 may include at least one of the following S4 and S5 (not shown in the figure).

S4: Obtain usage statuses respectively corresponding to the plurality of virtual cameras, where the usage status is in use or not in use.

When a virtual camera is in a controlled state, a usage status of the virtual camera may be considered to be in use. For example, a red team is a winner of a historical round, and the red team has three members, namely, a virtual object p1, a virtual object p2, and a virtual object p3. A birth point area of the red team includes two controllable virtual cameras d1 and d2. If none of the virtual objects p1, p2, and p3 has used the virtual cameras at a specific moment, and usage statuses of the virtual cameras d1 and d2 are both not in use. When the virtual object p1 controls the virtual camera d1, the usage status of the virtual camera d1 is in use for the virtual objects p2 and p3. In other words, when a usage status of a specific virtual camera in the plurality of virtual cameras is in use, the virtual camera cannot be controlled by other users.

FIG. 11 is an illustrative schematic diagram of a usage status of a virtual camera. In 1100, when an aim point of the first virtual object is directed towards a virtual camera 1101, a usage status 1102 of the virtual camera is displayed on the user interface. As shown in 1102, the usage status of the virtual camera is not in use, and a distance between the virtual camera and the first virtual object is 28 m. Moreover, the user is prompted to use a Z key to control the virtual camera. When the user taps the “Z key”, it is equivalent to performing a picture switching operation. The virtual camera acts as a first virtual camera, and the client displays a first camera picture obtained by capturing the birth point area by the first virtual camera in the user interface.

The selection of the virtual camera might not take into account the usage status of the virtual camera, and the client may select the first virtual camera from the plurality of virtual cameras according to the selection priorities. The client may select the first virtual camera from the plurality of virtual cameras according to the usage statuses and the selection priorities of the virtual cameras. For example, according to the usage statuses of the virtual cameras, the client may select, from at least one virtual camera whose usage status is not in use, a virtual camera with a highest selection priority as the first virtual camera.

S5: Select, from the virtual cameras whose usage statuses are not in use, a virtual camera with a highest selection priority as the first virtual camera.

There may be a plurality of virtual cameras that are not in use, and the virtual camera with the highest selection priority may be selected as the first virtual camera. A virtual camera closest to the first virtual object may be selected from the plurality of virtual cameras that are not in use as the first virtual camera. A virtual camera farthest from the first virtual object may be selected from the plurality of virtual cameras that are not in use as the first virtual camera. A virtual camera closest to the second virtual object may be selected from the plurality of virtual cameras that are not in use as the first virtual camera. A virtual camera farthest from the second virtual object may be selected from the plurality of virtual cameras that are not in use as the first virtual camera. A virtual camera with a highest selection priority according to system configuration information may be selected from the plurality of virtual cameras that are not in use as the first virtual camera. A virtual camera with a highest selection priority according to user configuration information may be selected from the plurality of virtual cameras that are not in use as the first virtual camera.

Operation 340-2: Display the first camera picture obtained by capturing the birth point area by the first virtual camera.

Operation 360: Display, in response to a perspective adjustment operation on the first virtual camera, a second camera picture captured by the first virtual camera from an adjusted perspective.

Perspective adjustment operation: It is an operation for adjusting the perspective of the first virtual camera, so that the picture is switched from the first camera picture captured by the first virtual camera to the second camera picture captured by the first virtual camera. The perspective adjustment operation may be a trigger operation. The perspective adjustment operation may include but is not limited to at least one of the following: a click/tap operation, a swipe operation, a key operation, a gesture operation, and the like. In another example, the perspective adjustment operation is the swipe operation. The client adjusts the first camera picture in response to the user performing the swipe operation of extending or retracting two fingers, to zoom out or zoom in the virtual environment picture viewed by the user to obtain the second camera picture. In another example, in a case that there is a second virtual object in the first camera picture, in response to the perspective adjustment operation for adjusting a display style of the second virtual object in the camera picture, the client zooms in and captures the second virtual object to obtain a zoomed-in second camera picture.

In another example, the perspective adjustment operation is a click operation performed by a mouse. The user clicks on a first location point in the first camera picture using the mouse, so that the user can control the first virtual camera to rotate toward the first location point to obtain the second camera picture, where the first location point is at a center of the second camera picture. In another example, the perspective adjustment operation is a key operation. In response to a press operation on a left key, the client controls the first virtual camera to rotate left in the virtual environment. The user may use a peripheral to perform the click/tap operation on the second virtual object in the first camera picture to zoom in a photographing perspective of the first virtual camera, to obtain the zoomed-in second camera picture. When there are a plurality of second virtual objects in the camera picture, a zooming out operation may be performed to zoom out the photographing perspective of the first virtual camera to obtain a zoomed-out second camera picture. In the second camera picture, more virtual environment and more second virtual objects can be captured. The device where the client is located is not limited in this application. Therefore, the type of the perspective adjustment operation is not limited, and any operation for adjusting perspectives can be used.

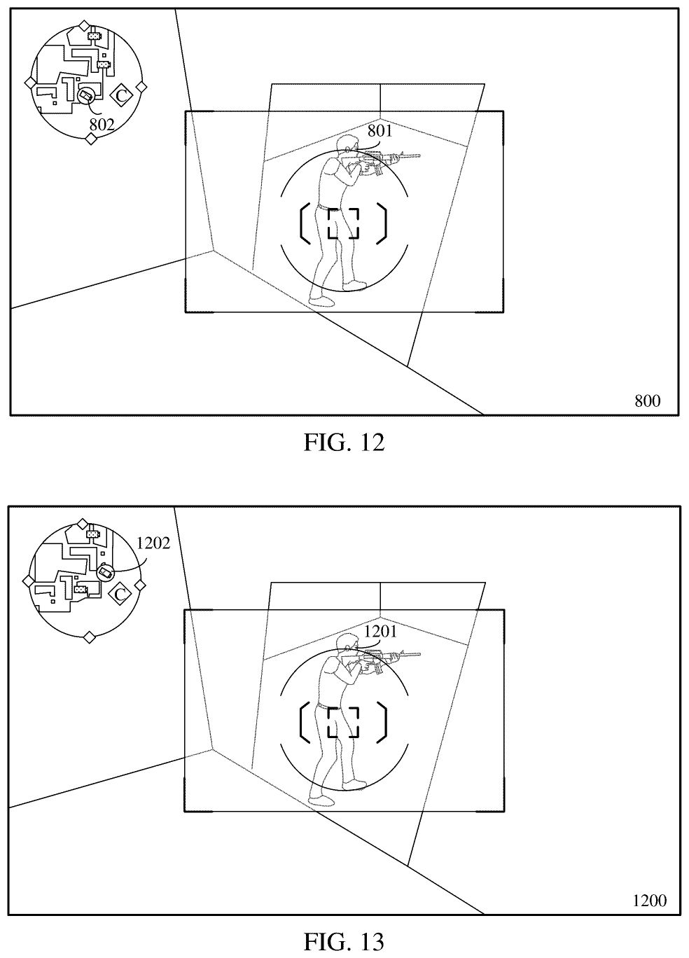

FIG. 12 is an illustrative schematic diagram of a camera picture. As shown in FIG. 12, a second virtual object 801 is displayed in a second camera picture 800. Morcover, a small map of a user interface shows that a current first virtual camera is 802. Comparing FIG. 8 and FIG. 12, it can be found that the perspective of the first virtual camera is changed, and thus the camera pictures are not the same.

The virtual camera may be controlled to rotate, move, zoom in, zoom out, and so on through the perspective adjustment operation, so that different control modes can be used for different battle situations, and the game is more strategic.

Operation 380 may include at least one of the following operations S6 to S10 (not shown in the figure).

S6: Obtain an attribute parameter of the perspective adjustment operation.

The attribute parameter may include a location adjustment amount and an orientation adjustment amount. The perspective adjustment operation performed by the user may correspond to the location adjustment amount and the orientation adjustment amount. In one example, the perspective adjustment operation performed by the user is to move by 1 cm in a direction of 20 degrees north by east on the screen. In this case, the location adjustment amount of the perspective adjustment operation is 1 cm, and the orientation adjustment amount of the perspective adjustment operation is 20 degrees north by cast.

S7: Determine an adjustment parameter of the first virtual camera according to the attribute parameter of the perspective adjustment operation, where the adjustment parameter includes at least one of a location adjustment amount and an orientation adjustment amount.

The attribute parameter of the perspective adjustment operation may be mapped to the adjustment parameter of the first virtual camera at a specific ratio. In one example, the location adjustment amount of 1 cm of the perspective adjustment operation is mapped to the location adjustment amount of 1 m of the first virtual camera by 100 times, and the orientation adjustment amount of 20 degrees north by cast of the perspective adjustment operation directly corresponds to the orientation adjustment amount of 20 degrees north by cast of the first virtual camera.

S8: Determine an adjusted perspective parameter of the first virtual camera according to a current perspective parameter of the first virtual camera and the adjustment parameter.

The current perspective parameter of the first virtual camera may be adjusted according to the location adjustment amount of 1 m of the first virtual camera and the orientation adjustment amount of 20 degrees north by cast of the first virtual camera, to obtain the adjusted perspective parameter. In one example, the current perspective parameters of the first virtual camera are a first location and a first direction respectively, and the adjusted perspective parameters are the first location plus the location adjustment amount and the first direction plus the orientation adjustment amount.

S9: Control the first virtual camera to capture the birth point area according to the adjusted perspective indicated by the adjusted perspective parameter, to obtain the second camera picture.

S10: Display the second camera picture.

Operation 380: Display, in response to a camera switching operation performed by the first virtual object, a third camera picture captured by a second virtual camera.

Operation 380 may include at least one of the following operations S11 to S12 (not shown in the figure).

S11: Determine the second virtual camera from the plurality of virtual cameras according to selection priorities respectively corresponding to the plurality of virtual cameras in response to the camera switching operation performed by the first virtual object.

Camera switching operation: It is an operation for switching cameras, so that the picture is switched from the first camera picture captured by the first virtual camera to the third camera picture captured by the second virtual camera. The camera switching operation may be a trigger operation. In one example, the client of the target application is installed on a mobile phone. The camera switching operation may be at least one of a press operation performed by the user on a mobile phone screen, a swipe operation performed by the user on the mobile phone screen, a touch and hold operation performed by the user on a gamepad connected to the mobile phone, and the like. When the user views that there is no second virtual object in the first camera picture, the user may switch, through an operation such as tapping a screen control, to the third camera picture captured by the second camera. In another example, the client of the target application is installed on a personal computer. The camera switching operation may be a tap operation on a peripheral (for example, a mouse or a keyboard). In some embodiments, the user taps a specific key (for example, a directional key) using the keyboard to switch the camera to obtain the third camera picture. The device where the client is located is not limited in this application. Therefore, the type of the camera switching operation is not limited, and any operation for switching cameras can be used for the technical solutions provided in the embodiments of this application.

The camera picture of the virtual camera is adjusted, to help find information needed by the user from the camera picture, improving the use effect of the virtual camera.

A virtual camera with a secondary selection priority may be used as the second virtual camera. A virtual camera that is second closest to the first virtual object may be selected from the plurality of virtual cameras as the second virtual camera. A virtual camera that is second farthest from the first virtual object may be selected from the plurality of virtual cameras as the second virtual camera. A virtual camera that is second closest to the second virtual object may be selected from the plurality of virtual cameras as the second virtual camera. A virtual camera that is second farthest from the second virtual object may be selected from the plurality of virtual cameras as the second virtual camera. A virtual camera with a second highest selection priority according to system configuration information may be selected from the plurality of virtual cameras as the second virtual camera. A virtual camera with a second highest selection priority according to user configuration information may be selected from the plurality of virtual cameras as the second virtual camera. The second virtual camera and the first virtual camera are at different locations in the birth point arca.

S12: Display the third camera picture obtained by capturing the birth point area by the second virtual camera.

FIG. 13 is an illustrative schematic diagram of a camera picture. A third camera picture 1200 is captured by a second virtual camera 1202. In this example, a second virtual object 1201 exists in the second camera picture 1200.

Operation 390: Display, in response to a marking operation on a second virtual object within a perspective range of the first virtual camera, marking information corresponding to the second virtual object in a virtual environment picture corresponding to a third virtual object of an own camp.

Operation 390 may further include: when the second virtual object appears within the perspective range of the first virtual camera, the user corresponding to the first virtual object performs the marking operation; and in response to the marking operation on the second virtual object within the perspective range of the first virtual camera, a marking request is sent to the server, where the marking request is configured for requesting the server to mark the second virtual object. The server sends parameter adjustment information to the client corresponding to the third virtual object after receiving the marking request, where the parameter adjustment information is configured for adjusting a parameter of the second virtual object in the client corresponding to the third virtual object. After the client corresponding to the third virtual object receives the parameter adjustment information, the marking information corresponding to the second virtual object is displayed in the virtual environment picture corresponding to the third virtual object in the own camp.

The own camp is a camp to which the first virtual object belongs, there is an obstruction between the second virtual object and the third virtual object, and the obstruction is configured to obstruct an observation line of sight of the third virtual object to the second virtual object. In other words, when the second virtual object is not marked, the third virtual object cannot observe the second virtual object due to the presence of the obstruction. On the contrary, after the second virtual object is marked, the third virtual object can view the marking information corresponding to the second virtual object.

Marking operation: It may be a touch operation, a press operation, or a tap operation on the mobile phone screen, a tap operation on a peripheral connected to the computer, or the like. For example, when the user views the second virtual object appearing in the picture captured by the first virtual camera displayed on the mobile phone screen, the marking operation can be implemented by touching or double-clicking the second virtual object. The marking operation may be implemented by clicking on the second virtual object using the mouse. The marking operation on the second virtual object may be implemented through a specific key. The type of the marking operation is not limited in this application.

The user may perform the marking operation only when the second virtual object appears within a target area of a field of view of the first virtual camera. The range of the target area is not limited in this application. When the user switches to the camera picture and the second virtual object appears in the camera picture, the marking operation may be automatically performed. The automatically performed marking operation may be performed by the client, and the marking request is sent after the marking operation is performed. When the user switches to the camera picture and the second virtual object appears in the camera picture, the marking operation does not need to be performed, and the second virtual object may be captured directly by the client and the marking request is sent to the server.

Marking request: It is a request sent to the server based on the marking operation. The marking request may be configured for requesting the server to adjust a parameter of the second virtual object in a client corresponding to another virtual object of the camp to which the first virtual object belongs. For example, the marking request is configured for requesting the server to perform adjustment to highlight the second virtual object in the client corresponding to the another virtual object of the camp to which the first virtual object belongs, to remind the another virtual object.

The marking operation may have a cooldown duration. After the marking operation is performed for the first time, the client can might be able to perform the marking operation for the next time only after the cooldown duration expires.

The server may receive the marking request sent by the client, adjust a character parameter that is of the second virtual object and that is in the marking request, and send the adjusted marking request to the client corresponding to the virtual object of the camp to which the first virtual object belongs. That is, the second virtual object may be displayed in another form on the client of the virtual object of the camp to which the first virtual object belongs.

The marked second virtual object may be marked and displayed in the virtual environment picture corresponding to the own camp. The marked second virtual object may be marked and displayed in the virtual environment picture corresponding to the first virtual object, or may be marked and displayed in a virtual environment picture corresponding to another virtual object in the own camp. The marked second virtual object may be displayed in the virtual environment picture corresponding to the own camp when an actual distance between a virtual object of the own camp and the marked second virtual object is less than a threshold. In one example, the marked second virtual object is displayed in the virtual environment picture corresponding to the own camp when a distance between a virtual object of the own camp and the marked second virtual object is less than 20 m.

There may be an obstruction between the second virtual object and the third virtual object in the own camp. If the second virtual object is marked and displayed, the marking information corresponding to the second virtual object is displayed in the virtual environment picture corresponding to the third virtual object. If the second virtual object is not marked and displayed, the marking information corresponding to the second virtual object is not displayed in the virtual environment picture corresponding to the third virtual object. Themarking information corresponding to the second virtual object may be information reflecting a location of the second virtual object behind the obstruction, for example, an outline or a silhouette of the second virtual object, or the second virtual object. This is not limited in this application. The marking information may be highlighted so that the user can view the marking information more quickly.

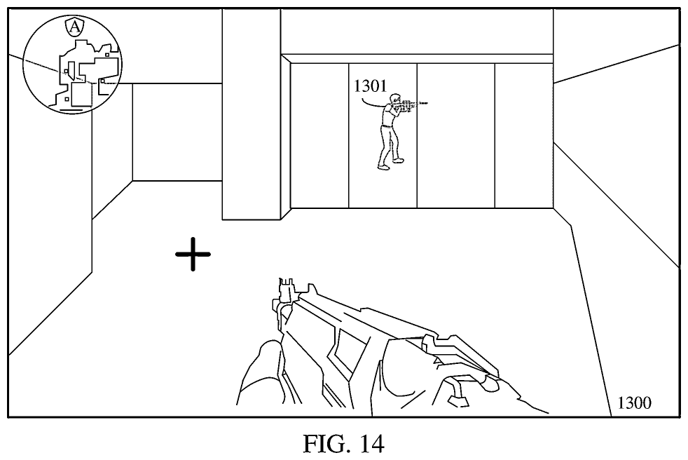

FIG. 14 is an illustrative schematic diagram of a user interface. A virtual environment picture 1300 is displayed on a user interface corresponding to the third virtual object (where the third virtual object described in this application is considered to be another virtual object of the camp to which the first virtual object belongs or any virtual object in the camp to which the first virtual object belongs), and marking information 1301 corresponding to the second virtual object is displayed on the virtual environment picture 1300. The first virtual object and the second virtual object are separated by an obstruction, namely, a wall. If the second virtual object is not marked and displayed, only the wall can be viewed in the virtual environment picture of the first virtual object and the marking information corresponding to the second virtual object cannot be viewed. The marking information corresponding to the second virtual object may be highlight state information of the second virtual object, or form information that is of the second virtual object and that is displayed in an infrared ray form, to remind the third virtual object. In other words, when the user controlling the first virtual object finds, by controlling the virtual camera, that the second virtual object exists in the birth point area, the marking operation may be performed on the second virtual object. The marking operation is performed through the server, so that the marking information (for example, the highlight state information) corresponding to the second virtual object can be displayed in the field of view of the third virtual object. Therefore, the user controlling the third virtual object can learn of the location of the second virtual object behind the obstruction, and thus can attack or pursuit, or perform another operation on the second virtual object. The marking information (for example, the highlight state information) corresponding to the second virtual object may exist for a threshold time in the field of view of the third virtual object. After the threshold time expires, the marking information of the second virtual object or the second virtual object is no longer displayed. In one example, the threshold time may be 8 seconds, and after 8 s, the marking information of the second virtual object or the second virtual object is no longer displayed in fields of view of other virtual objects of the camp to which the first virtual object belongs. In other words, after the threshold time expires, or the second virtual object is not marked and displayed, the second virtual object or the marking information corresponding to the second virtual object is no longer displayed in the virtual environment picture corresponding to the third virtual object. The second virtual object or the marking information corresponding to the second virtual object may be displayed in the threshold time within the field of view of the third virtual object. When the second virtual object is in motion, the second virtual object or the marking information corresponding to the second virtual object displayed within the field of view of the third virtual object is also dynamic. For example, the location of the second virtual object is marked in real time.

The marking information of the second virtual object may be dynamically displayed within a field of view of any virtual object of the camp to which the first virtual object belongs, so that the virtual objects of the camp to which the first virtual object belongs can all learn of real-time situations of surrounding virtual objects of an enemy camp in time, avoiding redundant operations, reducing exploration of the surroundings, further reducing operations that the user needs to perform, and reducing processing overhead of the terminal device.

The picture of the virtual camera switched first may be determined according to the selection priorities of the plurality of virtual cameras. The virtual camera with the highest selection priority may be used as the virtual camera switched first, to avoid the need to switch cameras multiple times to switch to a virtual camera needed for the user when switching to another virtual camera with a low selection priority, thereby improving the operation efficiency, saving resources required to run and load the game, and reducing the processing overhead of the terminal device.

Moreover, the virtual cameras not in use are determined from the plurality of virtual cameras, and the virtual camera with the highest selection priority is determined from the cameras not in use. In other words, when a virtual camera is used by a user, the virtual camera with the highest priority is selected from the virtual cameras not in use, to effectively avoid repeated operations, reduce overhead of the terminal device, and avoid wasting time.

Further, through the marking operation, the second virtual object can be marked and the marked second virtual object is marked and displayed in the virtual environment picture corresponding to the own camp. That is, if other virtual objects of the camp to which the first virtual object belongs also learn of the location of the second virtual object, the timing for virtual camera control is important. Controlling the virtual camera and marking the second virtual object at the right timing enable the virtual objects of the camp to which the first virtual object belongs to learn of the dynamics of the enemy in time for further deployments. When the camp to which the first virtual object belongs is a defending camp, the main work of the virtual objects of the camp to which the first virtual object belongs is to defend the birth point area. Therefore, gaining the right to control the camera in the birth point area is very important for the defense of the base tower. When an enemy sneaks around and attacks, it can be learned of immediately and settings can be made.

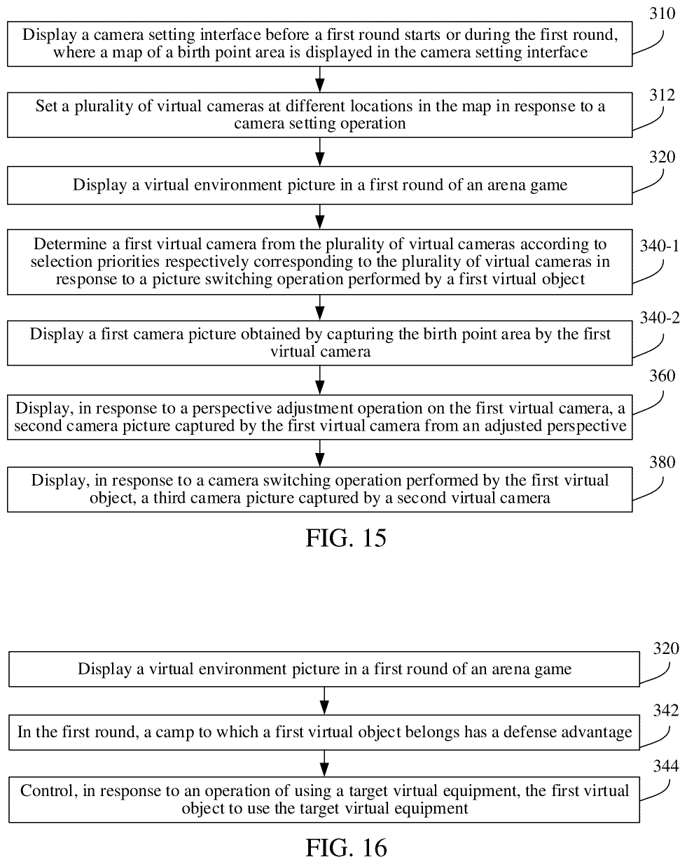

FIG. 15 is an illustrative flowchart of a picture display method. An entity executing the operations of the method may be the terminal device 10 in the solution implementation environment shown in FIG. 1. For example, the execution entity of each operation may be the client of the target application. In the following, for ease of description, the execution entity of cach operation being a “client” is only used for description. The method may include at least one of the following operations (310 to 380):

Operation 310: Display a camera setting interface before a current round starts or during the current round, where a map of a birth point area is displayed in the camera setting interface.

Before the current round starts, the camera setting interface may be displayed, where the camera setting interface includes the map of the birth point area. As shown in FIG. 7, a camera setting interface 602 may be displayed, through which a camera may be set by a user.

During the current round, the camera setting interface may be displayed. As shown in FIG. 8, a camera setting interface 703 may be displayed, through which a camera may be set by a user.

A size or a style of the camera setting interface is not limited in this application, and interfaces in which cameras are set before the game starts or during the game all belong to the technical solutions within the protection scope of this application.

Operation 312: Set a plurality of virtual cameras at different locations in the map in response to a camera setting operation.

The setting operation includes, but is not limited to, a touch operation, a press operation, and a click/tap operation on a screen, a tap operation on a peripheral, and the like.

The locations of the virtual cameras may be pre-set by a server, or the user may perform the camera setting operation, to set the virtual cameras at different sites in the map of the birth point area.

Operation 312 may include at least one of the following operations S13 and S14 (not shown in the figure). There is no order between operation S13 and operation S14, and only one of the operations may be performed, or both operations may be performed.

S13: Display a plurality of different camera sites in the map, and set, according to a selection operation on the camera sites, the virtual cameras at selected camera sites.

The selection operation may be a touch operation, a press operation, or a click/tap operation on the screen, a tap operation on a peripheral connected to the computer, or the like.

The server may set a plurality of virtual camera sites in a birth point area of a winner of a historical round, and before the game starts or during the game, the user selects some of the plurality of camera sites according to different environments or depending on whether the user is a defending party or an attacking party. In one example, five different camera sites are displayed in the map. According to a selection operation performed by the user on the camera sites, the user selects three camera sites, and sets virtual cameras at the three camera sites.

S14: Display a set virtual camera in the map, and adjust, in response to a movement operation on the virtual camera, a location of the virtual camera in the map according to the movement operation.

The movement operation may be a touch operation, a press operation, or a swipe operation on the screen, a tap operation on a peripheral connected to the computer, or the like.

Operation 320: Display a virtual environment picture in a current round of an arena game.

Operation 340-1: Determine a first virtual camera from a plurality of virtual cameras according to selection priorities respectively corresponding to the plurality of virtual cameras in response to a picture switching operation performed by the first virtual object.

Operation 340-2: Display the first camera picture obtained by capturing the birth point area by the first virtual camera.

Operation 360: Display, in response to a perspective adjustment operation on the first virtual camera, a second camera picture captured by the first virtual camera from an adjusted perspective.

Operation 380: Display, in response to a camera switching operation performed by the first virtual object, a third camera picture captured by a second virtual camera.

Based on the above, the locations of the virtual cameras may be determined by setting the sites of the virtual cameras before the game starts or during the game, so that the user controlling the first virtual object can determine the virtual cameras at different sites according to the ever-changing game. This further tests game strategies of the user and expands operability of the game. In addition, based on the adjustment parameter of the adjustment operation and the current perspective parameter, the adjusted perspective parameter is determined, so that a reaction speed of the game is accelerated, the calculation of the perspective parameter is simplified, and the costs of the game are reduced. Certainly, the layout of the sites also takes into consideration of game situations. The camera sites are set at proper locations, which facilitates rationalization and maximization of resources and facilitates the operation of the game.

FIG. 16 is an illustrative flowchart of a picture display method. An entity executing the operations of the method may be the terminal device 10 in the solution implementation environment shown in FIG. 1. For example, the execution entity of each operation may be the client of the target application. In the following, for ease of description, the execution entity of cach operation being a “client” is only used for description. The method may include at least one of the following operations (320 to 344):

Operation 320: Display a virtual environment picture in a current round of an arena game.

Operation 342: A camp to which a first virtual object belongs may have a defense advantage, and in some embodiments, the defense advantage may be an increase in defense power of the first virtual object, an increase in attack power of the first virtual object, or the like. Details of the defense advantage are not limited in this application.

In some embodiments, operation 342 includes at least one of the following operations S15 and S16 (not shown in the figure).

S15: If the camp to which the first virtual object belongs is a defending camp in the current round, defense duration of the camp to which the first virtual object belongs for the birth point area is shortened from first duration to second duration.

The defending camp may need to defend for the first duration, and the attacking camp may need to defend for the third duration after occupying the base tower. The first duration may be greater than the third duration. The defense duration may be calculated as cumulative duration. For example, when the defending camp starts to defend the base tower, countdown of the first duration for the defending camp begins. When the base tower is occupied by the attacking camp in the middle of the game, the countdown of the first duration for the defending camp stops and countdown of the third duration for the attacking camp begins. When the defending camp re-captures the base tower, the countdown of the first duration for the defending camp continues. The statistics are the cumulative defense duration. In one example, the first duration for which the defending camp needs to defend is three minutes and the third duration for which the attacking camp needs to defend is 35 s.

If the first virtual object is a winner of a historical round of the current round, and the camp to which the first virtual object belongs is a defending camp in the current round, the defense duration of the camp to which the first virtual object belongs for the birth point area may be controlled to be shortened from the first duration to the second duration. The second duration is less than the first duration. In one example, the duration for which the defending camp to which the first virtual object belongs needs to defend is changed from 3 minutes to 2 minutes and 30 s.

S16: If the camp to which the first virtual object belongs is an attacking camp in the current round, defense duration of the camp to which the first virtual object belongs after attacking and occupying a defending camp is controlled to be shortened from the third duration to fourth duration.

If the first virtual object is a winner of a historical round of the current round, and the camp to which the first virtual object belongs is an attacking camp in the current round, the defense duration of the camp to which the first virtual object belongs after attacking and occupying the defending camp may be controlled to be shortened from the third duration to the fourth duration. The fourth duration is less than the third duration. In one example, the defense duration of the camp to which the first virtual object belongs after attacking and occupying the defending camp is changed from 35 s to 25 s.

Operation 344: Control, in response to an operation of using a target virtual equipment, the first virtual object to use the target virtual equipment.

Virtual equipment: It may be at least one of a virtual attack equipment, virtual clothing, and a virtual vehicle. Virtual attack equipment: It is a virtual item held by the first virtual object in the virtual environment for attack, and is, for example, a virtual pistol, a virtual rifle, a virtual sniper rifle, or a virtual shotgun. Virtual clothing: It is clothes or accessories attached to a surface of the first virtual object in the virtual environment, and is, for example, a virtual shirt, a virtual long skirt, a virtual hat, or virtual glasses. Virtual vehicle: It is a virtual item that is used by the first virtual object in the virtual environment and that can move quickly, and is, for example, a virtual car, a virtual bicycle, a virtual tank, a virtual airplane, or a virtual hot air balloon.

The target virtual equipment may be at least one of multiple virtual equipments. The target virtual equipment may be set by the server. The target virtual equipment may be autonomously determined by the winner of the historical round of the current round. The target virtual equipment may be set before the round starts or during the round.

The usage operation may be a touch operation, a press operation, or a tap operation on a mobile phone screen, a tap operation on a peripheral connected to the computer, or the like.

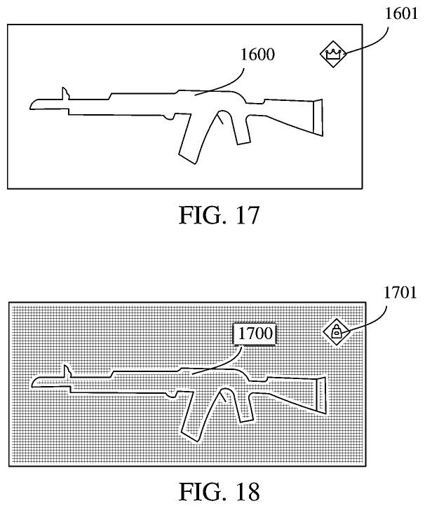

A winner of a historical round of the current round may have a permission to unlock the target virtual equipment, and a loser of a historical round of the current round does not have the permission to unlock the target virtual equipment. In one example, the target virtual equipment is a large sniper rifle. If the first virtual object is a winner of a historical round of the current round, the first virtual object is controlled to use the large sniper rifle in response to an operation of using the large sniper rifle. Referring to FIG. 17 and FIG. 18, FIG. 17 is an illustrative schematic diagram of a target virtual equipment, where the target virtual equipment is a large sniper rifle 1600, and there is a mark 1601 in the upper right corner indicating that the current team is a winner of a historical round of the round. Therefore, the target virtual equipment is unlocked for use by all virtual objects of the current team. FIG. 18 is an illustrative schematic diagram of a target virtual equipment, where the target virtual equipment is a large sniper rifle 1700, and there is a mark 1701 in the upper right corner indicating that the current team is not a winner of a historical round of the round. Therefore, the target virtual equipment cannot be unlocked for use by all virtual objects of the current team, and none of the virtual objects in the current team can use the target virtual equipment.

After operation 320 is performed, one of operations 340, 342, and 344 may be performed, or operations 340, 342, and 344 may all be performed. In other words, when the first virtual object is a winner of a historical round of the current round, the first virtual object can obtain three advantages. The first advantage is the right to control the virtual camera in the birth point arca. The virtual camera may be controlled through an operation such as a picture switching operation or a perspective adjustment operation, to obtain the field of view of the birth point area. The second advantage is the shorten defense time. The attacking party and the defending party both need to defend the base tower, and the shorten defense time increases the possibility of winning. The third advantage is that different virtual equipments can be used, which can not only improve attributes, but also distinguish the winner of the historical round of the current round, further improving competitive experience of the user. Some of or all the three advantages may be given to the winner of the historical round of the current round. The play of the overall arena game is more diverse, and the implementation of round point advantages is more abundant. In addition, the rules of competition are expanded, and the use of resources in the game is maximized.

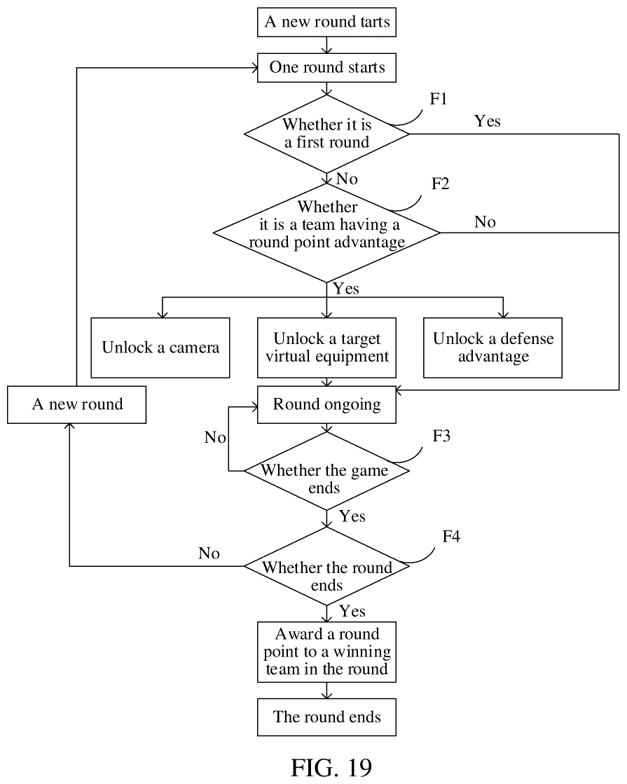

FIG. 19 is an illustrative flowchart of a picture display method. An entity executing the operations of the method may be the terminal device 10 in the solution implementation environment shown in FIG. 1. For example, the execution entity of each operation may be the client of the target application. In the following, for case of description, the execution entity of cach operation being a “client” is only used for description. The method may include at least one of the following operations (F1 to F4):

F1: Determine whether a current round is a first round. After a new round starts, a server determines whether the current round is a first round, where the first round is the first round after an arena game starts. If the new round is the first round, no team on the field has a round point advantage and the round proceeds normally. If the new round is not the first round, operation F2 is performed.

F2: Determine whether a current team is a team having a round point advantage.

If it is determined that the new round is not the first round, the server determines, according to winning information of a previous round, which teams have round point advantages, and only the teams having the round point advantages can gain corresponding rights and interests. If the current team is a team having the round point advantage, three major advantages are unlocked.

First, a camera is unlocked. A team having a round point advantage first re-selects a birth point after the new round starts. After obtaining an instruction of selecting the birth point from the user, the client sends the instruction to the server, where the instruction includes location information of the birth point and identity (ID) information of the team having the round point advantage. The server unlocks a camera around the birth point according to the location information of the birth point, and gives the control right to the corresponding team according to the ID information. The team having the round point advantage in the game may tap the Z key on the keyboard to remotely enter a field of view of the camera. In the field of view of the camera, dynamics in the scene can be observed to check if any enemies appear. After obtaining an instruction of switching the field of view from the user, the client obtains a game picture in the field of view of the camera from the server and displays the game picture on the client. If there are a plurality of cameras in the scene, a previous/next camera field of view can be switched to by pressing Q/E until a desirable field of view of the camera is entered. After obtaining an instruction of switching fields of view of different cameras from the user, the client obtains game pictures in fields of view of a plurality of cameras from the server, and switches between the game pictures up and down for display on the client according to a mouse operation performed by the user. When the field of view of the camera is controlled, whether an enemy target appears in a front range of the camera may be checked through the mouse. If there is an enemy target in the field of view, the cursor may be moved to the target and a left button of the mouse may be clicked to highlight the target. After the highlighting, a teammate can view the highlighted enemy information in his or her field of view. When the user clicks on an enemy character in the game picture in the field of view of the camera, the client obtains an instruction of marking the enemy, and then sends the instruction to the server. The server adjusts a display parameter corresponding to the enemy character according to enemy character information carried in the instruction, and sends the display parameter to a client corresponding to the teammate of the user in the game, so that the client displays the enemy according to the updated display parameter, and in particular, highlights an outline of the enemy. If the enemy is located just behind a penetrable wall, the teammate may take use of this information and attack the enemy by a penetrating shot from the back of the wall.

Second, a target virtual equipment is unlocked. The server further gives a permission according to the ID information of the team having the round point advantage to allow the corresponding team to use a special virtual equipment, to unlock the target virtual equipment for the team having the round point advantage. The team having the round point advantage may then click on a virtual backpack to view the unlocked target virtual equipment, and equip them with the target virtual equipment in the game.

Third, a defense advantage is unlocked. Finally, the server further adjusts a time parameter of the corresponding team according to the ID information of the team having the round point advantage, and subtracts a time length from the timing duration for the team with the advantage. In other words, the defense duration for the team with the advantage is shorter.

The server broadcasts a result of calculating the round point advantages to all users before the game, and the clients display the corresponding information according to respective identities. After the three major advantages are unlocked, the game proceeds normally.

F3: Determine whether the game ends. After the game ends, it is determined whether the game ends. If the game ends, operation F4 is performed. If the game has not ended, the current game is continued.

F4: Determine whether the round ends. If the round ends, a round point is awarded to a winning team in the round. The server awards a round point advantage to the winning team in the round. If the round has not ended, a next small round is started.

The following describes an illustrative apparatus, which can be used for performing the various methods described herein. For details not disclosed in the apparatus below, reference may be made to the methods described herein.

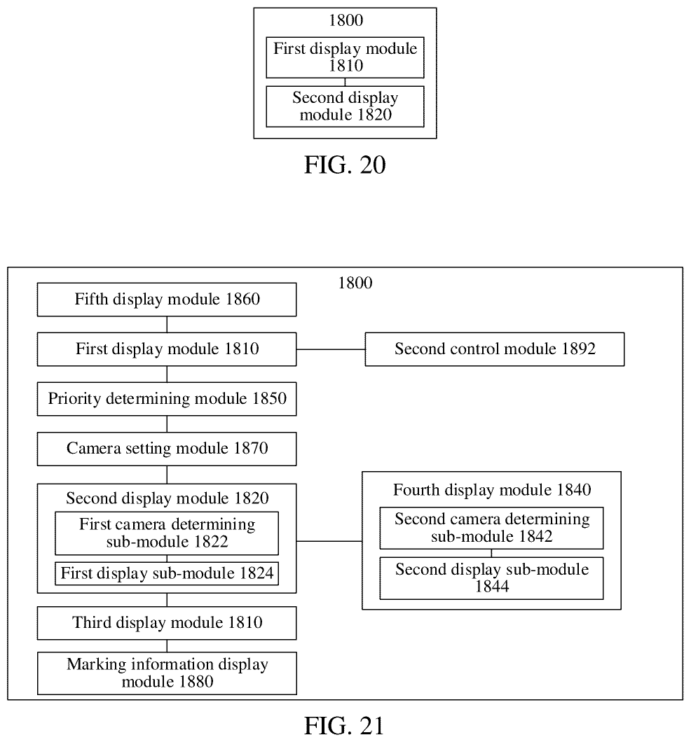

FIG. 20 is a block diagram of an illustrative picture display apparatus. The apparatus has functions of implementing the herein described methods. The functions may be implemented by hardware, or may be implemented by hardware executing corresponding software. The apparatus may be the foregoing terminal device, or may be disposed in a terminal device. As shown in FIG. 20, the apparatus 1800 may include a first display module 1810, a second display module 1820.

The first display module 1810 is configured to display a virtual environment picture in a first round of an arena game, the virtual environment picture being a display picture of a virtual environment of the first round observed from a perspective corresponding to a first virtual object participating in the first round, the first virtual object being a winner of a historical round of the first round, a first virtual camera being set in a birth point area of the first virtual object in the first round, and the first virtual object having a right to control the first virtual camera.

The second display module 1820 is configured to display, in response to a picture switching operation performed by the first virtual object, a first camera picture captured by the first virtual camera.

As shown in FIG. 21, the apparatus may further include a marking information display module 1880.

The marking information display module 1880 is configured to display, in response to a marking operation on a second virtual object within a perspective range of the first virtual camera, marking information corresponding to the second virtual object in a virtual environment picture corresponding to a third virtual object of an own camp, where the second virtual object and the first virtual object belong to different camps, the own camp is a camp to which the first virtual object belongs, there is an obstruction between the second virtual object and the third virtual object, and the obstruction is configured to obstruct an observation line of sight of the third virtual object to the second virtual object.

The birth point area may include a plurality of virtual cameras.

As shown in FIG. 21, the second display module 1820 may include a first camera determining sub-module 1822 and a first display sub-module 1824. The first camera determining sub-module 1822 is configured to determine the first virtual camera from the plurality of virtual cameras according to selection priorities respectively corresponding to the plurality of virtual cameras in response to the picture switching operation performed by the first virtual object. The first display sub-module 1824 is configured to display the first camera picture obtained by capturing the birth point area by the first virtual camera.

The first camera determining sub-module 1822 may be configured to obtain usage statuses respectively corresponding to the plurality of virtual cameras, where the usage status is in use or not in use. The first camera determining sub-module 1822 is configured to select, from the virtual cameras whose usage statuses are not in use, a virtual camera with a highest selection priority as the first virtual camera, where the birth point area includes a plurality of virtual cameras.

As shown in FIG. 21, the apparatus may further include a fourth display module 1840, configured to display, in response to a camera switching operation performed by the first virtual object, a third camera picture captured by a second virtual camera. The second virtual camera and the first virtual camera are at different locations in the birth point area.

As shown in FIG. 21, the fourth display module 1840 may include a second camera determining sub-module 1842 and a second display sub-module 1844. The second camera determining sub-module 1842 is configured to determine the second virtual camera from the plurality of virtual cameras according to selection priorities respectively corresponding to the plurality of virtual cameras in response to the camera switching operation performed by the first virtual object. The second display sub-module 1844 is configured to display the third camera picture obtained by capturing the birth point area by the second virtual camera.

As shown in FIG. 21, the apparatus may further include a priority determining module 1850. The priority determining module 1850 is configured to determine the selection priorities respectively corresponding to the plurality of virtual cameras according to distances between the first virtual object and the plurality of virtual cameras; or the priority determining module 1850 is configured to determine the selection priorities respectively corresponding to the plurality of virtual cameras according to distances between a second virtual object and the plurality of virtual cameras, where the second virtual object and the first virtual object belong to different camps; or the priority determining module 1850 is configured to determine the selection priorities respectively corresponding to the plurality of virtual cameras according to priority configuration information, where the priority configuration information is configured by a system or configured by a user.

As shown in FIG. 21, the apparatus may further include a fifth display module 1860 and a camera setting module 1870. The fifth display module 1860 is configured to display a camera setting interface before the first round starts or during the first round, where a map of the birth point area is displayed in the camera setting interface. The camera setting module 1870 is configured to set the plurality of virtual cameras at different locations in the map in response to a camera setting operation.

As shown in FIG. 21, the camera setting module 1870 may be configured to display a plurality of different camera sites in the map, and set, according to a selection operation on the camera sites, the virtual cameras at selected camera sites; or the camera setting module 1870 is configured to display a set virtual camera in the map, and adjust, in response to a movement operation on the virtual camera, a location of the virtual camera in the map according to the movement operation.

As shown in FIG. 21, the apparatus may further include a third display module 1830.

The third display module 1830 is configured to display, in response to a perspective adjustment operation on the first virtual camera, a second camera picture captured by the first virtual camera from an adjusted perspective.

The third display module 1830 may be configured to obtain an attribute parameter of the perspective adjustment operation; determine an adjustment parameter of the first virtual camera according to the attribute parameter of the perspective adjustment operation, where the adjustment parameter includes at least one of a location adjustment amount and an orientation adjustment amount; determine an adjusted perspective parameter of the first virtual camera according to a first perspective parameter of the first virtual camera and the adjustment parameter; control the first virtual camera to capture the birth point area according to the adjusted perspective indicated by the adjusted perspective parameter, to obtain the second camera picture; and display the second camera picture.

As shown in FIG. 21, the apparatus may further include a request sending module 1880, configured to send, in a case that there is a second virtual object belonging to a different camp than the first virtual object within the perspective range of the first virtual camera, a marking request to a server in response to a marking operation on the second virtual object, where the marking request is configured for requesting to mark the second virtual object. The marked second virtual object is marked and displayed in a virtual environment picture corresponding to an own camp, and the own camp is a camp to which the first virtual object belongs.

A camp to which the first virtual object belongs may have a defense advantage, where the defense advantage is for shortening defense duration of the camp to which the first virtual object belongs.

The defense advantage may include: if the camp to which the first virtual object belongs is a defending camp in the first round, defense duration of the camp to which the first virtual object belongs for the birth point area is controlled to be shortened from first duration to second duration; or the first control module 1890 is configured to control, if the camp to which the first virtual object belongs is an attacking camp in the first round, defense duration of the camp to which the first virtual object belongs after attacking and occupying a defending camp to be shortened from third duration to fourth duration.

As shown in FIG. 21, the apparatus may further include a second control module 1892, configured to control, in response to an operation of using a target virtual equipment, the first virtual object to use the target virtual equipment. A winner of a historical round of the first round has a permission to unlock the target virtual equipment, and a loser of a historical round of the first round does not have the permission to unlock the target virtual equipment.

The division of the foregoing functional modules is merely an example for description. In practical application, the functions may be assigned to and completed by different functional modules according to the requirements, that is, the internal structure of the device is divided into different functional modules, to implement all or some of the functions described above. In addition, the apparatus and methods described herein belong to the same conception. For the specific implementation process, reference may be made to the herein described methods, and details are not described herein again.

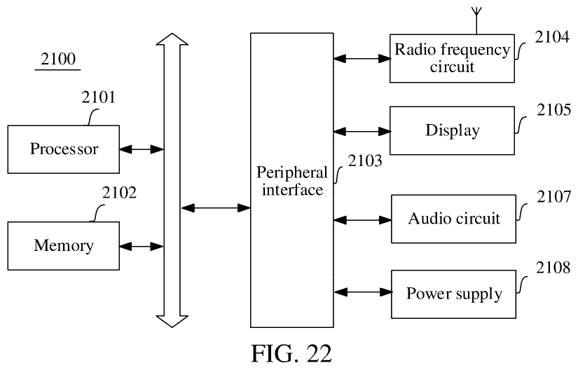

FIG. 22 is an illustrative block diagram of a structure of a terminal device 2100. The terminal device 2100 may be the terminal device 10 in the implementation environment shown in FIG. 1 for implementing the picture display methods described herein. Specifically:

Generally, the terminal device 2100 includes a processor 2101 and a memory 2102.

The processor 2101 may include one or more processing cores, for example, a 4-core processor or an 8-core processor. The processor 2101 may be implemented by using at least one hardware form of a digital signal processor (DSP), a field programmable gate array (FPGA), and a programmable logic array (PLA). The processor 2101 may also include a main processor and a coprocessor. The main processor is a processor configured to process data in an awake state, and is also referred to as a central processing unit (CPU). The coprocessor is a low power consumption processor configured to process the data in a standby state. The processor 2101 may be integrated with a graphics processing unit (GPU). The GPU is configured to be responsible for rendering and drawing content that a display needs to display. The processor 2101 may further include an artificial intelligence (AI) processor. The AI processor is configured to process computing operations related to machine learning.

The memory 2102 may include one or more computer-readable storage media that may be non-transitory. The memory 2102 may further include a high-speed random access memory (RAM) and a nonvolatile memory, for example, one or more disk storage devices or flash storage devices. The non-transitory computer-readable storage medium in the memory 2102 may be configured to store a computer program. The computer program is configured to be executed by one or more processors to implement the picture display method described above.

The terminal device 2100 may alternatively include: a peripheral interface 2103 and at least one peripheral. The processor 2101, the memory 2102, and the peripheral interface 2103 may be connected through a bus or a signal cable. Each peripheral may be connected to the peripheral interface 2103 through a bus, a signal cable, or a circuit board. Specifically, the peripheral includes: at least one of a radio frequency circuit 2104, a display 2105, an audio circuit 2107, and a power supply 2108.

A person skilled in the art may understand that the structure shown in FIG. 21 constitutes no limitation on the terminal device 2100, and the terminal device may include more or fewer components than those shown in the figure, or some components may be combined, or a different component deployment may be used.

In some aspects, a computer-readable storage medium is further provided. The storage medium stores a computer program. The computer program, when executed by a processor, implements the descreibd picture display methods.

The computer-readable storage medium may include: a read-only memory (ROM), a random access memory (RAM), a solid state drive (SSD), an optical disc, or the like. The random access memory may include a resistance random access memory (ReRAM) and a dynamic random access memory (DRAM).

In some aspects, a computer program product is further provided. The computer program product may include computer instructions, and the computer instructions are stored in a computer-readable storage medium. A processor of a terminal device reads the computer instructions from the computer-readable storage medium, and executes the computer instructions, so that the terminal device performs the foregoing picture display method.

What is claimed is:

1. A method comprising:
initiating an interactive virtual environment;
establishing a first spawn point for a first virtual object in a first round of an adversarial interactive game;
granting a right to control a first virtual camera in the interactive virtual environment to the first virtual object during the first round based on the first virtual object having won a previous round of the adversarial interactive game;
placing the first virtual camera at a location in the virtual environment based on the first spawn point;
controlling the first round of the interactive game based on user inputs received from a plurality of user terminals, wherein each terminal corresponds to a different user account and controls a different virtual object in the interactive game;
causing a virtual environment picture to be displayed on a first user terminal corresponding to the first virtual object, wherein the virtual environment picture corresponds to a real-time view of the virtual environment based on a then current location of the first virtual object in the virtual environment; and
causing, in response to user input originating from the first user terminal and indicating a picture switching operation, a virtual camera picture to be displayed on the first user terminal, wherein the virtual camera picture corresponds to a view based on the location and a lens direction of the first virtual camera.

2. The method according to claim 1, wherein after causing the virtual camera picture to be displayed, the method further comprises:
receiving user input originating from the first terminal requesting a marking operation on a second virtual object within a field of view of the first virtual camera; and
causing marking information corresponding to the second virtual object to be displayed on a second user terminal corresponding to an account controlling a third virtual object, wherein the third virtual object is on a same team as the first virtual object.

3. The method of claim 2, wherein the second virtual object and the first virtual object belong to different teams, there is an obstruction between the second virtual object and the third virtual object within the virtual environment, and the obstruction is configured to obstruct a line of sight by the third virtual object of the second virtual object.

4. The method according to claim 1, further comprising:
placing a plurality of virtual cameras based on the first spawn point, wherein the plurality of virtual cameras comprises the first virtual camera, wherein the granting comprises granting the first virtual object the right to control the plurality of the virtual cameras;
wherein the first virtual camera is selected from the plurality of virtual cameras based on one or more selection criteria.

5. The method according to claim 4, wherein the one or more selection criteria comprises a usage status corresponding to each of the plurality of virtual cameras, wherein any camera with a usage status of not in use may be selected, and any camera with a usage status of in use cannot be selected.

6. The method according to claim 4, further comprising:
receiving further user input originating from the first terminal indicating the camera switching operation
causing display on the first terminal of a second camera picture captured by a second virtual camera of the plurality of virtual cameras, wherein the second virtual camera and the first virtual camera have different fields of view within the virtual environment.

7. The method according to claim 6, further comprising:
determining the second virtual camera from the plurality of virtual cameras according to the one or more selection criteria.

8. The method according to claim 4, wherein the one or more selection criteria are based on one or more of:
a distance between the first virtual object and the corresponding virtual camera;
a distance between a second virtual object and the corresponding virtual camera; and/or
a user configured criterion.

9. The method according to claim 4, further comprising:
causing display of a camera setting interface on one or more terminals before the first round starts or during the first round, wherein a map based on the spawn point is included in the camera setting interface; and
setting the plurality of virtual cameras at different locations in the map in response to second user input received from one or more of the respective terminals on which the camera setting interface was displayed.

10. The method according to claim 9, wherein the second user input identifies one or more predefined camera sites in the virtual environment.

11. The method according to claim 9, wherein the second user input requests movement of one or more virtual cameras within the virtual environment.

12. The method according to claim 1, further comprising:
causing to display on the first terminal, in response to receiving second user input originating from the first terminal and requesting a perspective adjustment operation on the first virtual camera, a second camera picture captured by the first virtual camera from an adjusted perspective.

13. The method according to claim 12, wherein the causing to display the second camera picture comprises:
obtaining an attribute parameter of the perspective adjustment operation;
determining an adjustment parameter of the first virtual camera according to the attribute parameter of the perspective adjustment operation, wherein the adjustment parameter comprises at least one of a location adjustment amount and an orientation adjustment amount;
adjusting the first virtual camera within the virtual environment according to the adjustment parameter.

14. The method according to claim 1, wherein
assigning a defense advantage to a first team to which the first virtual object belongs, wherein the defense advantage comprises shortening a defense duration required by the first team in the first round.

15. The method according to claim 1, wherein the method further comprises:
granting the first virtual object permission to unlock a first virtual equipment based on the first virtual object having won the previous round;
determining one or more second virtual objects that are a loser of the previous round; and
denying access to the first virtual equipment to the one or more second virtual objects.

16. One or more non-transitory computer readable media storing computer readable instructions which, when executed by a processor, configure a data processing system to perform:
initiating an interactive virtual environment;
establishing a first spawn point for a first virtual object in a first round of an adversarial interactive game;
granting a right to control a first virtual camera in the interactive virtual environment to the first virtual object during the first round based on the first virtual object having won a previous round of the adversarial interactive game;
placing the first virtual camera at a location in the virtual environment based on the first spawn point;
controlling the first round of the interactive game based on user inputs received from a plurality of user terminals, wherein each terminal corresponds to a different user account and controls a different virtual object in the interactive game;
causing a virtual environment picture to be displayed on a first user terminal corresponding to the first virtual object, wherein the virtual environment picture corresponds to a real-time view of the virtual environment based on a then current location of the first virtual object in the virtual environment; and
causing, in response to user input originating from the first user terminal and indicating a picture switching operation, a virtual camera picture to be displayed on the first user terminal, wherein the virtual camera picture corresponds to a view based on the location and a lens direction of the first virtual camera.

17. The computer readable media according to claim 16, wherein the instructions further configure the data processing system to perform:
after causing the virtual camera picture to be displayed:
receiving user input originating from the first terminal requesting a marking operation on a second virtual object within a field of view of the first virtual camera; and
causing marking information corresponding to the second virtual object to be displayed on a second user terminal corresponding to an account controlling a third virtual object, wherein the third virtual object is on a same team as the first virtual object.

18. The computer readable media according to claim 16, wherein the instructions further configure the data processing system to perform:
placing a plurality of virtual cameras based on the first spawn point, wherein the plurality of virtual cameras comprises the first virtual camera, wherein the granting comprises granting the first virtual object the right to control the plurality of the virtual cameras;
wherein the first virtual camera is selected from the plurality of virtual cameras based on a usage status of each of the plurality of virtual cameras.

19. The computer readable media according to claim 16, further comprising:
causing display of a camera setting interface on one or more terminals before the first round starts or during the first round, wherein a map based on the spawn point is included in the camera setting interface; and
adjusting a location of the virtual camera in response to second user input received from one or more of the respective terminals on which the camera setting interface was displayed.

20. A data processing system comprising:
a processor; and
memory storing computer readable instructions which, when executed by the processor, configure the data processing system to perform:
initiating an interactive virtual environment;
establishing a first spawn point for a first virtual object in a first round of an adversarial interactive game;
granting a right to control a first virtual camera in the interactive virtual environment to the first virtual object during the first round based on the first virtual object having won a previous round of the adversarial interactive game;
placing the first virtual camera at a location in the virtual environment based on the first spawn point;
controlling the first round of the interactive game based on user inputs received from a plurality of user terminals, wherein each terminal corresponds to a different user account and controls a different virtual object in the interactive game;
causing a virtual environment picture to be displayed on a first user terminal corresponding to the first virtual object, wherein the virtual environment picture corresponds to a real-time view of the virtual environment based on a then current location of the first virtual object in the virtual environment; and
causing, in response to user input originating from the first user terminal and indicating a picture switching operation, a virtual camera picture to be displayed on the first user terminal. wherein the virtual camera picture corresponds to a view based on the location and a lens direction of the first virtual camera.
